(19) United States
(12) Patent Application Publication
(10) Pub. No.: US 2026/0265586 A1
(43) Pub. Date: Sep. 10, 2026

(54) COMPOSITION, LAMINATED FILM, MEMBER, ADHESION METHOD, AND SEALING METHOD

(71) Applicant: SONY GROUP CORPORATION, TOKYO (JP)

(72) Inventors: SHUHEI YAMAGUCHI, KANAGAWA (JP); HISAYA HARA, KANAGAWA (JP)

(21) Appl. No.: 19/166,314

(22) PCT Filed: Mar. 18, 2024
(86) PCT No.: PCT/JP2024/010505

§ 371 Date: Sep. 17, 2025

(30) Foreign Application Priority Data
Mar. 31, 2023 (JP) 2023-059450

(51) Int. Cl. C09J 7/38; B32B 7/023; B32B 7/06; B32B 7/12; B32B 27/18; C09J 5/00; C09J 11/06

(52) U.S. Cl. CPC C09J 7/385; B32B 7/023; B32B 7/06; B32B 7/12; B32B 27/18; C09J 5/00; C09J 11/06; C09J 2301/416

(57) ABSTRACT

A main object of the present technology is to provide a technology capable of suppressing an absorption wavelength of a composition from being fixed before exposure in relation to a composition for manufacturing a photocurable resin or a hologram recording medium. As a result of intensive studies, the present inventors have found that by including an absorption wavelength maintaining agent in a photocurable resin or a composition for manufacturing a hologram recording medium, it is possible to suppress fixation of an absorption wavelength of the composition before exposure and to improve long-term storability of the composition.

### TECHNICAL FIELD

The present technology relates to a composition, a laminated film, a member, an adhesion method, and a sealing method. More specifically, the present invention relates to a composition including an absorption wavelength maintaining agent, a laminated film and a member, and an adhesion method and a sealing method using the composition.

### BACKGROUND ART

Conventionally, there has been a demand for a technique for preventing a change in quality and achieving long-term storability in a case where a composition is stored.

For example, Patent Document 1 below discloses a technique in which a positive photoresist composition containing a novolak resin and a quinone diazide photosensitizer further contains a reduction inhibitor to suppress decomposition of the quinone diazide photosensitizer, which is an irreversible reaction, and to achieve storage stability.

### CITATION LIST

### Patent Document

Patent Document 1: Japanese Patent Application Laid-Open No. 11-232489

### SUMMARY OF THE INVENTION

### Problems to be Solved by the Invention

A main object of the present technology is to provide a technology capable of suppressing an absorption wavelength of a composition from being fixed before exposure in relation to a composition for manufacturing a photocurable resin or a hologram recording medium.

### Solutions to Problems

As a result of intensive studies, the present inventors have found that inclusion of an absorption wavelength maintaining agent in a composition for manufacturing a photocurable resin can improve long-term storability of the composition.

That is, the present technology provides a composition including: a sensitizing dye that reversibly changes an absorption wavelength of light; a polymerizable monomer; and an absorption wavelength maintaining agent.

The composition according to the present technology may further include a polymerization initiator. The polymerization initiator is preferably one or more onium compounds, and more preferably one or more of the onium compounds is a salt of a triarylborate-based compound.

In the composition according to the present technology, the absorption wavelength maintaining agent may be an oxidation-reduction inhibitor.

In the composition according to the present technology, the absorption wavelength maintaining agent may be included in an amount of 1 mol or more based on 1 mol of the sensitizing dye.

In the composition according to the present technology, the polymerizable monomer may be a cationic polymerizable monomer, and the absorption wavelength maintaining agent may be a reduction inhibitor. In this case, the reduction inhibitor is preferably at least one selected from a nitro compound, a peroxide, and a halogen-based compound, and more preferably at least one selected from a nitrobenzene sulfonate, a methanitrobenzene sulfonate, a nitronaphthalene sulfonate, a vanadate, a nitrite, a chlorate, a perchlorate, and a percarbonate. Furthermore, in this case, the cationic polymerizable monomer may be one or more cyclic ether-based compounds.

In the composition according to the present technology, the sensitizing dye may be at least one compound selected from a thiazine-based compound, an azine-based compound, and a cyanine-based compound.

The composition according to the present technology may further include a binder resin and a radical polymerizable organic monomer.

Next, the present technology provides a laminated film including one or more layers including the above composition. The laminated film of the present technology may include a substrate layer, a resin layer, and a release layer in this order, and the resin layer may include the composition of the present technology.

Furthermore, the present technology provides a member including a resin layer on at least a part of a surface, the resin layer being formed by exposing the composition.

The member according to the present technology may include a resin layer on at least a part of a surface, in which the resin layer includes a sensitizing dye or a derivative of the sensitizing dye that reversibly changes an absorption wavelength of light, a polymer of a polymerizable monomer, and an absorption wavelength maintaining agent.

Next, the present technology provides an object adhering method using the composition as an adhesive. In this case, a mixture of the above-mentioned composition and a polymerization initiator can also be used as an adhesive.

The present technology provides a sealing method using the composition as a sealant.

### BRIEF DESCRIPTION OF DRAWINGS

FIG. 1 is data showing a temporal change in a transmittance spectrum of a composition according to the present technology.

FIG. 2 is data showing the influence of the addition amount of an absorption wavelength maintaining agent on the storage stability of the composition according to the present technology.

FIG. 3 is an example of a laminated film according to the present technology.

FIG. 4 is a modification of the laminated film according to the present technology.

FIG. 5 is an example of a member according to the present technology.

FIG. 6 is a view illustrating an example of releasing a resin layer from a member according to the present technology.

FIG. 7 is a releasing step in a method for manufacturing the member according to the present technology using the laminated film according to the present technology.

FIG. 8 is a bonding step in a method for manufacturing the member according to the present technology using the laminated film according to the present technology.

FIG. 9 is an interference exposure step in a method of manufacturing the member according to the present technology using the laminated film according to the present technology.

FIG. 10 is a UV exposure step in a method of manufacturing the member according to the present technology using the laminated film according to the present technology.

FIG. 11 is a heating step in a method for manufacturing the member according to the present technology using the laminated film according to the present technology.

FIG. 12 is a schematic view illustrating an example in which interference fringes are recorded on a member according to the present technology by exposure.

FIG. 13 is a reaction formula showing reversible change of methylene blue.

FIG. 14 is a graph showing changes in the waveform of a transmittance spectrum before and after a high-temperature and high-humidity test of a composition containing an epoxide and a sensitizing dye.

FIG. 15 shows a reaction formula of methylene blue and an epoxide.

FIG. 16 is data showing a time-dependent change in a waveform of an absorption spectrum in a case where an absorption wavelength maintaining agent is not included.

FIG. 17 is a graph showing a linear function used to calculate absorbance retention rate at the time of storage.

### MODE FOR CARRYING OUT THE INVENTION

Preferred embodiments of the present technology will be described below. However, the following embodiments illustrate examples of representative embodiments of the present technology, and the present technology is not limited only to the following preferred embodiments, and can be freely changed within the scope of the present technology.

Embodiments of the present technology will be described in the following order.
1 First Embodiment (Hologram photosensitive composition)
2 Second Embodiment (Hologram photosensitive film)
3 Third embodiment (Example of hologram recording medium)
4 Fourth Embodiment (Example of hologram optical element)
5 Fifth Embodiment (Examples of optical device and optical part)
6 Sixth Embodiment (Example of method for forming hologram diffraction grating)
7 Seventh embodiment (Example as sealant)
8 Analysis method

### 1 First Embodiment

### [Composition]

The composition according to the present technology includes a sensitizing dye that reversibly changes an absorption wavelength of light, a polymerizable monomer, and an absorption wavelength maintaining agent.

### <Sensitizing Dye>

In the sensitizing dye contained in the composition according to the present technology, the absorption wavelength of light is reversibly changed by a reversible reaction.

Here, the “reversible reaction” is a chemical reaction under a condition that the equilibrium is not extremely biased to the production system, and refers to a reaction in a situation where a reverse reaction can also proceed.

The “absorption wavelength of light” refers to a wavelength at a maximal value of a waveform of an absorption spectrum with a horizontal axis as a wavelength and a vertical axis as an absorbance.

Furthermore, the “sensitizing dye” is a substance capable of causing “photosensitization”, and specifically refers to a substance that absorbs energy of light having a specific wavelength and transmits the energy to a reactant such as a polymerization initiator or a radical polymerizable organic monomer to cause a photochemical reaction such as a polymerization reaction of the reactant.

Here, the “photochemical reaction” refers to a chemical reaction caused by a substance that has absorbed light.

That is, the sensitizing dye contained in the composition according to the present technology is in equilibrium in a state where the absorption wavelength of light reversibly changes. The sensitizing dye contained in the composition according to the present technology is not particularly limited as long as it is the compound as described above, and includes, for example, at least one selected from the group consisting of a thiopyrylium salt dye, a merocyanine dye, a quinoline dye, a styrylquinoline dye, a ketocoumarin dye, a thioxanthene dye, a xanthene dye, a thiazine dye such as methylene blue, an azine dye, a phenazine dye, an oxonol dye, a cyanine dye, a rhodamine dye, a pyrylium salt dye, a cyclopentanone dye, a cyclohexanone dye, and the like.

The cyanine and merocyanine dyes include, for example, at least one selected from the group consisting of 3,3′-dicarboxyethyl-2, 2′-thiocyanine bromide, 1-carboxymethyl-1′-carboxyethyl-2, 2′-quinocyanine bromide, 1, 3′-diethyl-2, 2′-quinothiacyanine iodide, 3-ethyl-5-[(3-ethyl-2 (3H)-benzothiazolylidene)ethylidene]-2-thioxo-4-oxazolidine and the like.

The coumarin and the ketocoumarin dye include, for example, at least one selected from the group consisting of 3-(2′-benzimidazole)-7 diethylaminocoumarin, 3, 3′-carbonylbis(7-diethylaminocoumarin), 3, 3′-carbonylbiscoumarin, 3, 3′-carbonylbis(5, 7-dimethoxycoumarin), 3,3′-carbonylbis(7-acetoxycoumarin) and the like.

Furthermore, the sensitizing dye contained in the composition according to the present technology may include at least one ionic sensitizing dye. In a case where the composition according to the present technology includes an ionic sensitizing dye, the effect of improving the light absorption efficiency of the composition by the polyalcohol is particularly remarkable.

Furthermore, the sensitizing dye contained in the composition according to the present technology may include either or both of a dye having absorption in a visible light region and a UV sensitizing dye (anthracene compound and the like) added for the purpose of improving light efficiency at the time of UV irradiation.

Furthermore, only one kind of sensitizing dye contained in the composition according to the present technology may be used, or a plurality of kinds of sensitizing dyes may be used to respond to a plurality of wavelengths. The sensitizing dye may include at least two kinds of sensitizing dyes having absorption in the visible light region. In this case, the at least two sensitizing dyes may include at least one ionic sensitizing dye. In the sensitizing dye that absorbs light in the visible light region, the maximum value of the absorption spectrum of the sensitizing dye may exist in the visible light region. In the present specification, the visible light region refers to a wavelength range of 360 nm or more and 830 nm or less.

The content of the sensitizing dye contained in the composition according to the present technology is not particularly limited, but when the sensitizing dye is contained in an amount of, for example, 0.01% by mass or more, more preferably 0.1% by mass or more, and particularly preferably 0.3% by mass or more with respect to 100% by mass of the composition, photosensitization can be suitably caused.

The upper limit of the content of the sensitizing dye contained in the composition according to the present technology is not particularly limited, but can be suitably adjusted to, for example, 10% by mass or less, more preferably 1% by mass or less with respect to 100% by mass of the composition.

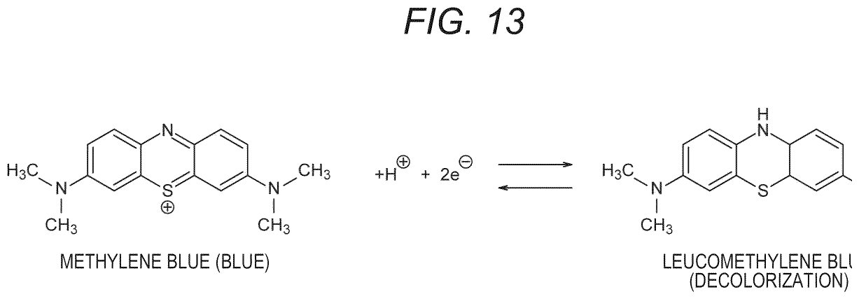

FIG. 13 is a reaction formula showing an equilibrium state of methylene blue as a sensitizing dye contained in the composition according to the present technology. The thiazine-based compound such as methylene blue can increase the phase separation of the composition according to the present technology after the photochemical reaction to improve the refractive index modulation degree Δn, and thus the composition according to the present technology can be suitably used, for example, in a case where the composition according to the present technology is used for applications such as holograms used for reproduction of holography.

Here, “holography” refers to generation of a three-dimensional image, and “hologram” refers to a medium on which interference fringes related to information of the three-dimensional image are recorded.

### <Polymerizable Monomer>

The “polymerizable monomer” contained in the composition according to the present technology is a monomer that is a low molecular weight compound, and refers to a compound capable of forming a polymer by repeating bonding of the monomer. In the composition according to the present technology, polymerization is promoted mainly by ultraviolet (UV: Ultra Violet) irradiation, heating, and the like, and the composition can be cured.

The polymerizable monomer contained in the composition according to the present technology is not particularly limited as long as it is a monomer capable of achieving the function described above, and may be a cationic polymerizable monomer or an anionic polymerizable monomer.

The polymerizable monomer can be effective for developing a high refractive index modulation amount (An). Furthermore, the polymerizable monomer may also be effective for preparing the adhesiveness, flexibility, hardness, and other physical characteristics of the photosensitive composition. The polymerizable monomer may include at least one selected from the group consisting of an ester-based plasticizer, an ether-based plasticizer, and the like.

The polymerizable monomer contained in the composition according to the present technology may be nonionic. In a case where the polymerizable monomer is nonionic, the light absorption efficiency of the composition including an ionic sensitizing dye is reduced, but if the composition includes a polyalcohol, the light absorption efficiency of the composition can be improved.

The reason for the improvement of the light absorption efficiency described above is considered to be as follows. Since the ionic sensitizing dye has poor dispersibility with respect to the nonionic polymerizable monomer, when the composition includes the nonionic polymerizable monomer, dispersibility of the ionic sensitizing dye with respect to the composition is deteriorated. By including the polyalcohol in the composition including the nonionic polymerizable monomer, the dispersibility of the ionic sensitizing dye in the composition is improved, and the light absorption rate of the composition is improved.

In a case where the polymerizable monomer contained in the composition according to the present technology is a cationic polymerizable monomer and one or more cyclic ether-based compounds are used, the high-temperature and high-humidity resistance of the composition according to the present technology can be improved. Therefore, even in a case where the composition according to the present technology is used for applications such as holograms under high-temperature and high-humidity conditions such as outdoor in summer, it is possible to suppress a change in diffraction wavelength.

Examples of the cyclic ether-based compound suitable as the polymerizable monomer contained in the composition according to the present technology include compounds such as epoxide (oxirane), oxetane, tetrahydrofuran, and tetrahydropyran. These can be used as a single compound or in combination of a plurality of compounds.

The epoxide described above compound includes, for example, glycidyl ether and the like. The glycidyl ether includes, for example, at least one selected from the group consisting of allyl glycidyl ether, phenyl glycidyl ether, 1,4-butanediol diglycidyl ether, 1,5-pentanediol diglycidyl ether, 1,6-hexanediol diglycidyl ether, 1,8-octanediol diglycidyl ether, 1, 10-decanediol diglycidyl ether, 1, 12-dodecanediol diglycidyl ether, ethylene glycol diglycidyl ether, diethylene glycol diglycidyl ether, polyethylene glycol diglycidyl ether, polypropylene glycol diglycidyl ether, neopentyl glycol diglycidyl ether, bisphenol A diglycidyl ether, bisphenol F diglycidyl ether, trimethylolpropane diglycidyl ether, glycerin triglycidyl ether, diglycerol triglycidyl ether, sorbitol polyglycidyl ether, pentaerythritol polyglycidyl ether, and the like.

The oxetane compound described above includes, for example, at least one selected from the group consisting of 3-ethyl-3 hydroxymethyloxetane, 2-ethylhexyloxetane, xylylene bisoxetane, 3-ethyl-3 {[(3-ethyloxetane-3-yl) methoxy]methyl}oxetane, 2-hydroxyethyl vinyl ether, 4-hydroxybutyl vinyl ether, diethylene glycol monovinyl ether, 2-ethylhexyl vinyl ether, and the like.

Furthermore, in a case where an epoxide is used among the cyclic ether-based compounds as the polymerizable monomer contained in the composition according to the present technology, the transparency after UV exposure of the composition according to the present technology can be improved.

Here, the epoxide as the cyclic ether-based compound is a compound having one or more epoxy groups in the molecule, and the number of epoxy groups of the molecule is not particularly limited. For example, a compound having one epoxy group, a compound having two epoxy groups, a compound having three or more epoxy groups, and the like can be suitably used, and as described above, one kind of compound may be used alone or a plurality of compounds may be used in combination according to the use situation of the composition according to the present technology. It can also be used in combination with other cyclic ether-based compounds.

Note that as the number of epoxy groups in the molecule increases, when a resin including the composition according to the present technology is bonded to a member main body including glass and the like as described later, crosslinking occurs between the glass and the like on the member main body surface and the resin, and the adhesive strength with the member main body is improved. Therefore, when the resin layer as a hologram is released from the member main body after a hologram and the like is produced and used, it is preferable to adjust adhesiveness and releasability by adjusting the number of epoxy groups in the composition according to the present technology, for example, by combining a compound having one epoxy group and a compound having two epoxy groups.

In a case where the composition according to the present technology is used for a hologram used for reproduction of holography, the content of the polymerizable monomer contained in the composition is not particularly limited, but if the polymerizable monomer is contained in an amount of, for example, 1% by mass or more, more preferably 10% by mass or more, and particularly preferably 20% by mass or more with respect to 100% by mass of the composition, polymerization is efficiently promoted by ultraviolet irradiation, heating, and the like, and the composition according to the present technology can be effectively cured.

The upper limit of the content of the polymerizable monomer contained in the composition according to the present technology in a case where the composition is used for hologram application is not particularly limited, but can be suitably adjusted to, for example, 50% by mass or less, more preferably 45% by mass or less, and particularly preferably 40% by mass or less with respect to 100% by mass of the composition.

In a case where the composition according to the present technology is used for applications other than hologram applications, the content of the polymerizable monomer contained in the composition is also not particularly limited, in a manner similar to the case of hologram applications, but the content ratio can be adjusted according to the composition of other components.

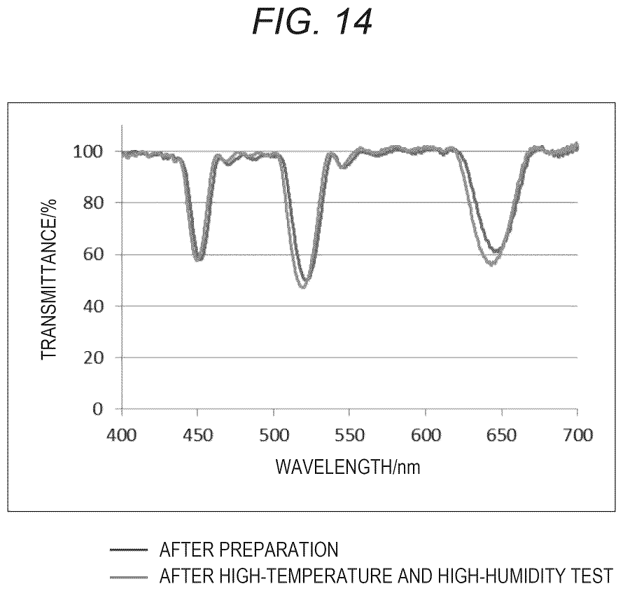

FIG. 14 is a graph showing changes in the waveform of a spectrum with the wavelength on the horizontal axis and the transmittance on the vertical axis before and after a high-temperature and high-humidity test in a case where 6-hexanediol diglycidyl ether as an epoxide is used as a polymerizable monomer contained in a hologram diffraction grating using the composition according to the present technology. In this case, it can be confirmed that the change in the waveform is suppressed by containing the epoxide, and high high-temperature and high-humidity resistance is obtained.

Note that the high-temperature and high-humidity test described above was performed after 100 hours of a hologram diffraction grating containing methylene blue as a sensitizing dye and 6-hexanediol diglycidyl ether as a polymerizable monomer was passed under conditions of 60° C. and 80% humidity.

### <Polymerization Initiator>

The composition according to the present technology may further include a polymerization initiator. The “polymerization initiator” in the present technology refers to a substance necessary for easily generating radicals or ions and initiating a chain polymerization reaction. The composition according to the present technology is a compound capable of initiating a polymerization reaction of a polymerizable monomer or a radical polymerizable organic monomer.

The polymerization initiator that can be contained in the composition according to the present technology can be appropriately selected according to the characteristic of the polymerizable monomer and radical polymerizable organic monomer contained in the composition according to the present technology. The photopolymerization initiator may include a radical polymerization initiator (radical generator), a cationic polymerization initiator (acid generator), or those having both functions. Note that the photopolymerization initiator may include an anionic polymerization initiator (base generator).

For example, in a case where a cationic polymerizable monomer is used as the polymerizable monomer, from the viewpoint of obtaining a high refractive index modulation amount (An) and diffraction efficiency, it is preferable to include at least one of an organic boron salt-based initiator such as an organic boron compound or a derivative thereof and an onium salt-based initiator such as an onium compound or a derivative thereof, and it is more preferable to contain both of the organic boron salt-based initiator and the onium salt-based initiator. On the other hand, in a case where an anionic polymerizable monomer is used as the polymerizable monomer, a radical initiator or a derivative thereof can be suitably used. These polymerization initiators may be used singly or in combination of a plurality of compounds.

Here, the onium compound is a compound including an onium ion and is also referred to as an onium salt. In a case where an onium compound is used as the polymerization initiator in the composition according to the present technology, one or more of the onium compounds may be a salt of an organic boron compound such as a triarylborate-based compound. In this case, it can be suitably used as a polymerization initiator of a cyclic ether-based compound such as an epoxide, and by using these in combination, the high-temperature and high-humidity resistance of the composition according to the present technology can be improved.

The onium salt-based initiator such as an onium compound or a derivative thereof includes at least one selected from the group consisting of, for example, tris(4-(4-acetylphenyl)thiophenyl)sulfonium tetrakis(pentafluorophenyl)borate (product name: Irgacure290, manufactured by BASF Japan Ltd.), diphenyl(4-(phenylsulfanyl)phenyl)sulfonium trifluoride tris(pentafluoroethane-1-ide)phosphate (manufactured by San-Apro Ltd., product code: CPI-210S), 4-isopropyl-4′-methyldiphenyliodonium tetrakis(pentafluorophenyl)borate (product code: 10591 manufactured by Tokyo Chemical Industry Co., Ltd.), (2-methylphenyl) (2,4, 6-trimethylphenyl) iodonium trifluoromethanesulfonate mesityl(o-tolyl) iodonium triflate (manufactured by Tokyo Chemical Industry Co., Ltd., product code: M2907), and (4-methylphenyl) (2,4,6-trimethylphenyl) iodonium trifluoromethanesulfonate mesityl(p-tolyl) iodonium triflate (manufactured by Tokyo Chemical Industry Co., Ltd., product code: M2909).

The organic boron salt-based initiator such as an organic boron compound or a derivative thereof includes, for example, at least one selected from the group consisting of a triarylborate-based compound such as tetrabutylammonium butyltriphenylborate (manufactured by Showa Denko K. K., product name: P3B), tetrabutylammonium=butyltrinaphthylborate (manufactured by Showa Denko K. K., product name: N3B), and the like.

In a case where a triarylborate-based compound is used as the polymerization initiator in the present technology, the triarylborate-based compound is not particularly limited, but for example, a triarylsulfonium salt and the like can be suitably used.

In the composition according to the present technology, a polymerization initiator may be contained in the composition in advance, or the polymerization initiator may be added at the time of use. Suitable use forms can be suitably employed depending on the use of the composition according to the present technology.

Examples of the form in which the polymerization initiator is added at the time of use include a case in which a composition including a component other than the polymerization initiator and a composition including the polymerization initiator are mixed at the time of use, but the form is not limited to this use form.

The content of the polymerization initiator that can be contained in the composition according to the present technology is not particularly limited, but if the polymerization initiator is contained in an amount of, for example, 1% by mass or more, more preferably 3% by mass or more, and particularly preferably 5% by mass or more with respect to 100% by mass of the composition, the polymerization reaction of the polymerizable monomer or the radical polymerizable organic monomer can be suitably initiated.

The upper limit of the content of the polymerization initiator that can be contained in the composition according to the present technology is not particularly limited, but can be adjusted to, for example, 50% by mass or less, more preferably 30% by mass or less, and particularly preferably 25% by mass or less with respect to 100% by mass of the composition.

### <Absorption Wavelength Maintaining Agent>

The “absorption wavelength maintaining agent” contained in the composition according to the present technology is a material that maintains the absorption wavelength of light of the composition according to the present technology, particularly a material that suppresses fixation of the absorption wavelength of light due to a bias toward either oxidation or reduction in the equilibrium state of the sensitizing dye when the sensitizing dye whose absorption wavelength reversibly changes is exposed to energy of light.

The composition according to the present technology can suppress the fixation of the absorption wavelength of light of the sensitizing dye by containing the absorption wavelength maintaining agent. Therefore, it is possible to prevent the absorption wavelength of the composition from being fixed before exposure for manufacturing a photocurable resin using the composition according to the present technology. Therefore, the storability of the composition is improved, and long-term storage relative to conventional products can be achieved.

The absorption wavelength maintaining agent contained in the composition according to the present technology is not particularly limited as long as it is a material having the function described above, and examples thereof include an oxidation-reduction inhibitor and the like that prevents oxidation-reduction of a sensitizing dye.

As the oxidation-reduction inhibitor that can be suitably used as the absorption wavelength maintaining agent contained in the composition according to the present technology, the oxidation inhibitor or the reduction inhibitor can be appropriately selected and used in accordance with a situation in which the sensitizing dye is biased to either oxidation or reduction due to exposure to light energy in a state of containing either the cationic polymerizable monomer or the anionic polymerizable monomer.

For example, in a case where the composition according to the present technology uses a cationic polymerizable monomer as the polymerizable monomer, the sensitizing dye can be biased to the reduced state if the composition is exposed to light energy, so that the reduction inhibitor can be suitably used as the absorption wavelength maintaining agent.

The composition according to the present technology can effectively suppress the fixation of the absorption wavelength of the sensitizing dye by including 1 mol or more of the absorption wavelength maintaining agent with respect to 1 mol of the sensitizing dye.

In a case where the content of the absorption wavelength maintaining agent with respect to 1 mol of the sensitizing dye is 1 mol or more, the fixation of the absorption wavelength of the sensitizing dye can be effectively suppressed, but the content is not particularly limited thereto, and the content of 0.1 mol or more, 0.5 mol or more, and the like can also be appropriately selected depending on the combination of the sensitizing dye and the absorption wavelength maintaining agent.

In a case where the polymerizable monomer included in the composition according to the present technology is a cationic polymerizable monomer and a reduction inhibitor is used as an absorption wavelength maintaining agent, at least one compound selected from a nitro compound, a peroxide such as a percarbonate, a halogen-based compound, a vanadate, or a nitrite can be suitably used as the reduction inhibitor, and a nitro compound is particularly preferable. These compounds may be used singly or in combination of a plurality of compounds.

In this case, in the composition according to the present technology, the nitro compound that can be used as the reduction inhibitor is not particularly limited as long as it is a compound having a nitro group, but for example, nitrobenzene sulfonate such as nitrobenzene sulfonate or methanitrobenzene sulfonate, or nitronaphthalene sulfonate can be suitably used, and among them, nitrobenzene sulfonate is preferable, and methanitrobenzene sulfonate is particularly preferable.

Similarly, the peroxide that can be used as the reduction inhibitor is not particularly limited as long as it is a compound having a peroxide structure, but for example, a percarbonate and the like can be suitably used.

Furthermore, the halogen-based compound that can be used as the reduction inhibitor is not particularly limited as long as it is a compound having a halogen element in the molecule, but for example, chlorate and perchlorate can be suitably used.

Here, as the element such as a metal forming the salt of the compound described above, any element can be used according to the characteristics of the molecular structure constituting the acid. For example, a salt can be suitably formed with an element such as an alkali metal such as sodium or potassium, or an alkaline earth metal such as magnesium or calcium, and among them, an alkali metal is preferable, and sodium is particularly preferable.

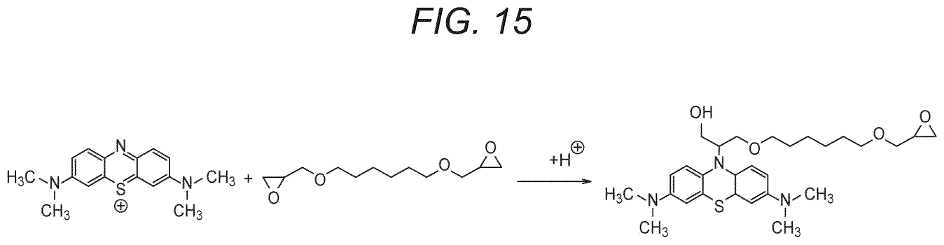

FIG. 15 is a reaction formula showing that in a composition in which the sensitizing dye is methylene blue and the polymerizable monomer is 6-hexanediol diglycidyl ether as a cationic polymerizable monomer, the methylene blue is irreversibly reduced by reaction with the 6-hexanediol diglycidyl ether, whereby the absorption wavelength of light is fixed.

In this case, if the composition according to the present technology includes, for example, a reducing agent such as sodium m-nitrobenzenesulfonate as the absorption wavelength maintaining agent, the reaction between methylene blue and 6-hexanediol diglycidyl ether can be suppressed, and the fixation of the absorption wavelength of the composition before exposure can be suitably suppressed.

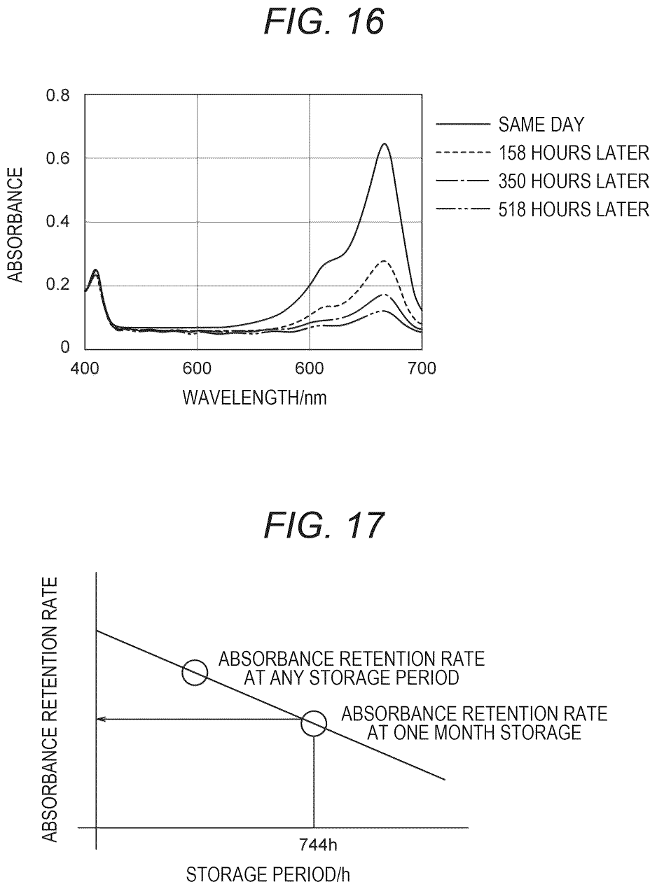

FIG. 16 is data showing a time-dependent change in the waveform of an absorption spectrum in a case where a composition in which the sensitizing dye is methylene blue and the polymerizable monomer is 6-hexanediol diglycidyl ether as a cationic polymerizable monomer does not contain an absorption wavelength maintaining agent. It can be confirmed that the absorbance in the vicinity of 660 nm decreases with the lapse of time.

### <Radical Polymerizable Organic Monomer>

The composition according to the present technology may further include a radical polymerizable organic monomer. The “radical polymerizable organic monomer” contained in the composition according to the present technology is a monomer that is a low molecular weight compound, and is a compound that can cause a polymerization reaction as a photochemical reaction by light energy transmitted from a sensitizing dye to produce a polymer.

In a mode in which the composition according to the present technology includes a radical polymerizable organic monomer, in a case where exposure is performed by creating brightness and darkness within the irradiation area by a method such as irradiating the composition with interference light, a photochemical reaction proceeds by light energy transmitted from a sensitizing dye in a region where the irradiation amount of light is large, and a polymer of the radical polymerizable organic monomer is synthesized. On the other hand, the polymerization reaction does not proceed in a region where the irradiation amount of light is relatively smaller than that in the region.

For this reason, a concentration gradient of the polymer of the radical polymerizable organic monomer occurs based on the difference in the progress of the polymerization reaction described above, and a phase separation structure is formed in the composition according to the present technology.

By utilizing the above characteristics, in a case where the composition according to the present technology includes a radical polymerizable organic monomer, the composition can record interference fringes. Therefore, the composition can be suitably used as a hologram used for reproduction of holography.

The radical polymerizable organic monomer that can be contained in the composition according to the present technology is not particularly limited as long as it is a compound that can cause a polymerization reaction as a photochemical reaction by light energy transmitted from the sensitizing dye to produce a polymer. For example, a radical polymerizable compound, a cation polymerizable compound, or both are included. The radical polymerizable organic monomer may include an anion polymerizable compound. The radical polymerizable organic monomer may include a polymerizable monomer, a polymerizable oligomer, or a mixture thereof. The radical polymerizable organic monomer may include a monofunctional compound, a polyfunctional compound, or a mixture thereof. The radical polymerizable organic monomer may include one polymerizable compound or two or more polymerizable compounds.

The radical polymerizable organic monomer that can be contained in the composition according to the present technology specifically includes, for example, a compound represented by the following General Formula (1). The compound has a high refractive index, good transparency, and good solubility in an organic solvent.

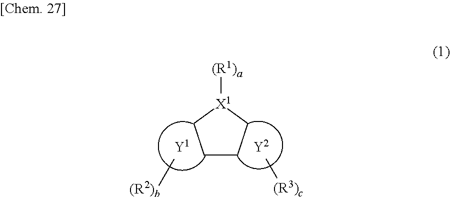

In General Formula (1), X¹ represents an oxygen atom, a nitrogen atom, a phosphorus atom, a carbon atom, or a silicon atom. In a case where X¹ represents an oxygen atom, a is 0, in a case where X¹ represents a nitrogen atom or a phosphorus atom, a is 1, and in a case where X¹ represents a carbon atom or a silicon atom, a is 2.

Y¹ and Y² each represent a benzene ring or a naphthalene ring. Y¹ and Y² may simultaneously represent a benzene ring, or a case may be excluded in which Y¹ and Y² simultaneously represent a benzene ring. In a case where Y¹ and/or Y² represents a benzene ring, b or c corresponding to Y¹ and/or Y² representing the above-described benzene ring is 4. In a case where Y¹ and/or Y² represents a naphthalene ring, b and/or c corresponding to Y¹ and/or Y² representing the above-described naphthalene ring is 6.

R¹ to R³ each represent hydrogen or a substituent represented by *—Z¹(R⁴)_{d} (in which * represents a binding site). In a case where a plurality of R¹s, a plurality of R²s, and a plurality of R³s are present, the plurality of R¹s, the plurality of R²s, and the plurality of R³s may be of a same kind or of different kinds, and all of the plurality of R¹s, the plurality of Res, and the plurality of R³s in General Formula (1) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may include an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of a same kind or of different kinds, and all of the plurality of R⁴s in General Formula (1) is not simultaneously hydrogen.

In General Formula (1) described above, X¹ represents an oxygen atom, a nitrogen atom, a phosphorus atom, a carbon atom, or a silicon atom. Furthermore, it is considered that an effect of the present disclosure can also be expected for Group 14 elements, Group 15 elements, and Group 16 elements (however, transition metals are excluded) other than the above-described atoms.

Among the above-described atoms, an oxygen atom, a nitrogen atom, and a carbon atom, which are representative elements in an organic compound, are preferable from the viewpoint of ease of synthesis of a compound, and the atomic refraction of each atom is as follows. Oxygen atom: 1.6 to 2.2, nitrogen atom: 3.5 to 4.4, carbon atom: 1.7 to 2.4 (Optical Review, Vol. 44, No. 8, 2015, p. 298-303). In the present embodiment, X¹ in General Formula (1) is preferably a nitrogen atom, which has a high value of atomic refraction, from the viewpoint of obtaining a compound having a high refractive index.

That is, in the present embodiment, the radical polymerizable organic monomer polymerizable compound may have the following structure.

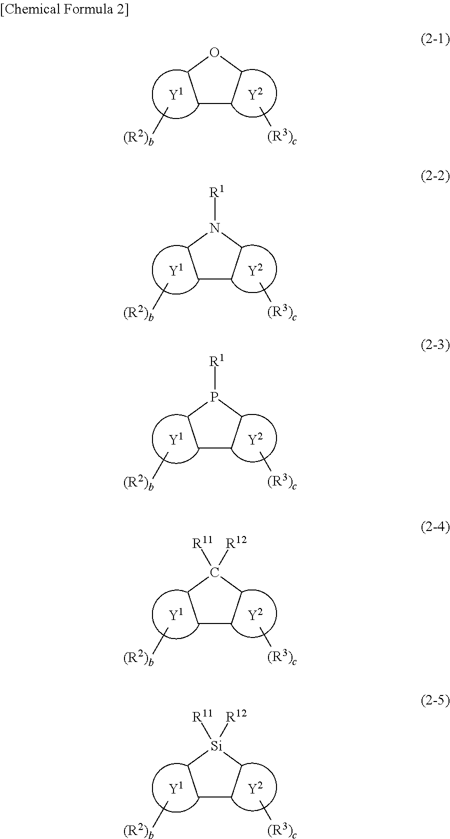

In General Formulas (2-1) to (2-5), Y¹ and Y² each represent a benzene ring or a naphthalene ring. Y¹ and Y² may simultaneously represent a benzene ring, or a case may be excluded in which Y¹ and Y² simultaneously represent a benzene ring. In a case where Y¹ and/or Y² represents a benzene ring, b or c corresponding to Y¹ and/or Y² representing the above-described benzene ring is 4. In a case where Y¹ and/or Y² represents a naphthalene ring, b and/or c corresponding to Y¹ and/or Y² representing the above-described naphthalene ring is 6. R¹, R², R³, R¹¹ and R¹² each represent hydrogen or a substituent represented by *—Z¹ (R⁴)_{d} (in which * represents a binding site). In a case where a plurality of R¹s, a plurality of Res, and a plurality of R's are present, the plurality of R¹s, the plurality of Res, and the plurality of R's may be of a same kind or of different kinds, and all of R¹s, R²s, R³s, R¹¹s, and R¹²s in General Formulas (2-1) to (2-5) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may include an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of a same kind or of different kinds, and all of the plurality of R⁴s in General Formulas (2-1) to (2-5) is not simultaneously hydrogen.

Furthermore, in General Formula (1) described above, Y¹ and Y² each represent a benzene ring or a naphthalene ring. Y¹ and Y² may simultaneously represent a benzene ring, or a case may be excluded in which Y¹ and Y² simultaneously represent a benzene ring.

The molecular refraction of phenyl(C₆H₅) and naphthyl(C₁₀H₇) is as follows. Phenyl(C₆H₅): 25.5, naphthyl(C₁₀H₇): 43.3 (Optical Review, Vol. 44, No. 8, 2015, p. 298-303). In the present embodiment, Y¹ and Y² each more preferably represent a naphthalene ring, which has a high value of molecular refraction, from the viewpoint of obtaining a compound having a high refractive index.

That is, in the present embodiment, the radical polymerizable organic monomer can have the following structure.

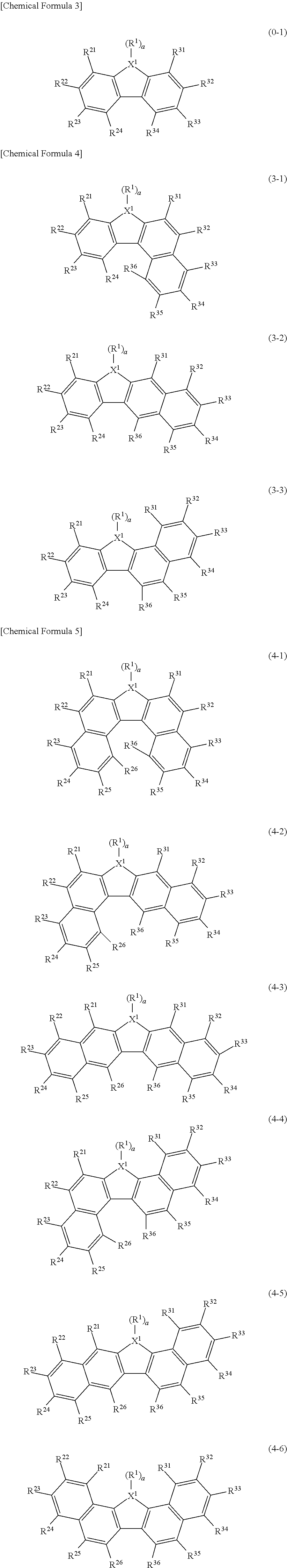

In General Formulas (0-1), (3-1) to (3-3), and (4-1) to (4-6), X¹ represents an oxygen atom, a nitrogen atom, a phosphorus atom, a carbon atom, or a silicon atom. In a case where X¹ represents an oxygen atom, a is 0, in a case where X¹ represents a nitrogen atom or a phosphorus atom, a is 1, and in a case where X¹ represents a carbon atom or a silicon atom, a is 2.

R¹, R²¹ to R²⁶, and R³¹ to R³⁶ each represent hydrogen or a substituent represented by *—Z¹ (R⁴)_{d} (in which * represents a binding site). R¹, R²¹ to R²⁶, and R³¹ to R³⁶ may be of a same kind or of different kinds. Furthermore, in a case where a plurality of R¹s is present, the plurality of R¹s may be of a same kind or of different kinds. However, R¹, R²¹ to R²⁶, and R³¹ to R³⁶ in General Formulas (0-1), (3-1) to (3-3), and (4-1) to (4-6) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may include an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of a same kind or of different kinds, and all of the plurality of R⁴s in General Formulas (0-1), (3-1) to (3-3), and (4-1) to (4-6) is not simultaneously hydrogen.

In General Formula (1) described above, Z¹ represents a single bond, a divalent or higher saturated hydrocarbon group, or a divalent or higher unsaturated hydrocarbon group. The saturated hydrocarbon group or the unsaturated hydrocarbon group may include an ether bond and/or a thioether bond.

In a case where Z¹ is a divalent or higher saturated hydrocarbon group, the saturated hydrocarbon group may be a linear, branched, or cyclic substituted or unsubstituted hydrocarbon group. In general, the larger simple carbon chain number an organic compound has, the more easily the organic compound tends to obtain solubility. Meanwhile, the larger simple carbon chain number an organic compound has, the lower refractive index the organic compound tends to have. Therefore, the saturated hydrocarbon group preferably has a simple carbon chain number of 1 to 15, and more preferably 1 to 10.

Furthermore, in a case where Z¹ is a divalent or higher unsaturated hydrocarbon group, the unsaturated hydrocarbon group may be a linear, branched, or cyclic substituted or unsubstituted hydrocarbon group or an aromatic group. The unsaturated hydrocarbon group preferably has a simple carbon chain number of 1 to 15, and more preferably 1 to 10. In a case where the unsaturated hydrocarbon group includes an aromatic group, the aromatic group is preferably a substituted or unsubstituted divalent or higher aromatic group represented by the following Chemical Formulas (5-1) to (5-8). Four or more benzene rings linearly connected absorb light in the visible light region and have a color, and therefore may be undesirable from the viewpoint of transparency. Therefore, the aromatic group preferably does not have a structure in which four or more benzene rings are linearly arranged, and the aromatic group preferably has a linear shape including a benzene ring, a naphthalene ring, or an anthracene ring.

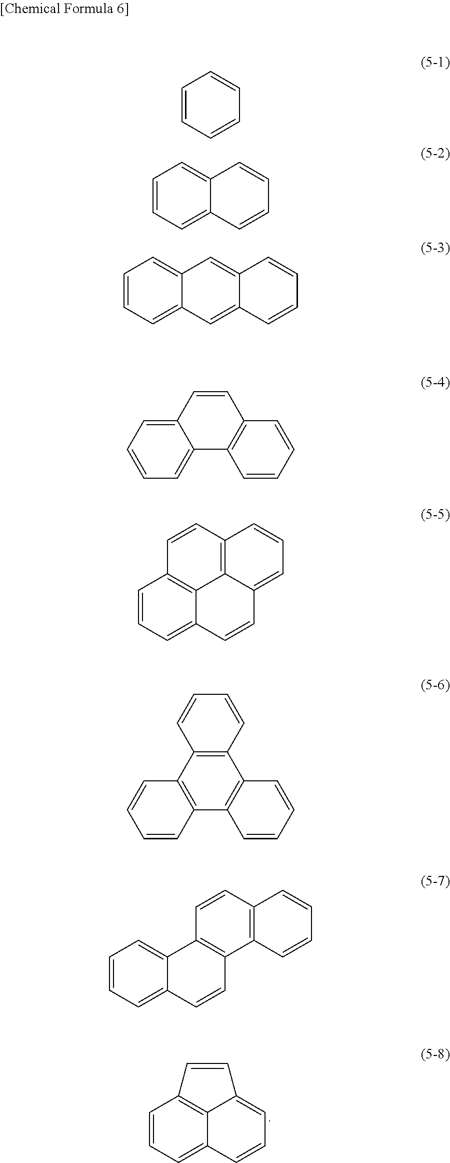

In General Formula (1) described above, examples of the polymerizable substituent represented by R⁴ include those including a polymerizable unsaturated group and those including a reactive substituent. Examples of the polymerizable substituents including a polymerizable unsaturated group include a vinyl group, an acrylic group, a methacrylic group, an acrylamide group, a methacrylamide group, a cyanoacrylate group, a cyanomethacrylate group, a vinyl ether group, a vinyl cyanide group, a vinyl nitrate group, conjugated polyene groups, vinyl halide groups, vinyl ketone groups, a styryl group and the like. Examples of the polymerizable substituents including a reactive substituent include an epoxy group, an oxetane group, a hydroxyl group, an amino group, a carboxyl group, acid anhydride groups, acid halide groups, an isocyanate group and the like.

In General Formula (1) described above, X¹ preferably represents a nitrogen atom, and Y¹ and Y² each preferably represent a naphthalene ring. That is, the above-described compound is preferably a compound represented by the following General Formula (1-1).

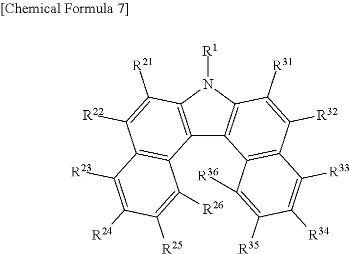

In General Formula (1-1), R¹, R²¹ to R²⁶, and R³¹ to R³⁶ represent hydrogen or a substituent represented by *—Z¹ (R⁴)_{d} (in which * represents a binding site). R¹, R²¹ to R²⁶, and R³¹ to R³⁶ may be of a same kind or of different kinds. However, R¹, R²¹ to R²⁶, and R³¹ to R³⁶ are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may include an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of a same kind or of different kinds, and all of the plurality of R⁴s in General Formula (1-1) is not simultaneously hydrogen.

In General Formula (1-1), R¹ is preferably a substituent represented by *—Z¹ (R⁴)_{d} (in which * represents a binding site), and R²¹ to R²⁶, and R³¹ to R³⁶ preferably represent hydrogen.

Furthermore, in General Formula (1) described above, X¹ preferably represents a carbon atom, and Y¹ and Y² each preferably represent a naphthalene ring. That is, the above-described compound is preferably a compound represented by the following General Formula (1-2).

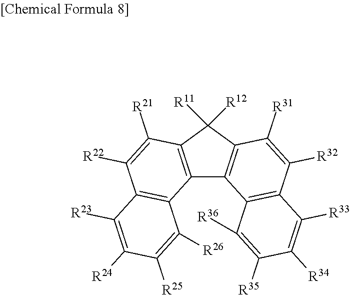

In General Formula (1-2), R¹¹, R¹², R²¹ to R²⁶, and R³¹ to R³⁶ represent hydrogen or a substituent represented by *—Z¹ (R⁴)_{d} (in which * represents a binding site). R¹¹, R¹², R²¹ to R²⁶, and R³¹ to R³⁶ may be of a same kind or of different kinds. However, R¹¹, R¹², R²¹ to R²⁶, and R³¹ to R³⁶ in the General Formula (1-2) are not simultaneously hydrogen.

Z¹ represents a single bond, a divalent or higher saturated hydrocarbon group, or a divalent or higher unsaturated hydrocarbon group, and the saturated hydrocarbon group or the unsaturated hydrocarbon group may include an ether bond and/or a thioether bond. In a case where Z¹ represents a single bond, d is 1, and in a case where Z¹ represents a saturated hydrocarbon group or an unsaturated hydrocarbon group, d is an integer of 1 or more.

R⁴ represents hydrogen or a polymerizable substituent. In a case where a plurality of R⁴s is present, the plurality of R⁴s may be of a same kind or of different kinds, and all of the plurality of R⁴s in General Formula (1-2) is not simultaneously hydrogen.

In General Formula (1-2), R¹¹ and/or R¹² is preferably a substituent represented by *—Z¹ (R⁴)_{d} (in which * represents a binding site), and R²¹ to R²⁶, and R³¹ to R³⁶ preferably represent hydrogen.

Preferred exemplary compounds for the radical polymerizable organic monomer of the present embodiment have the following chemical formula.

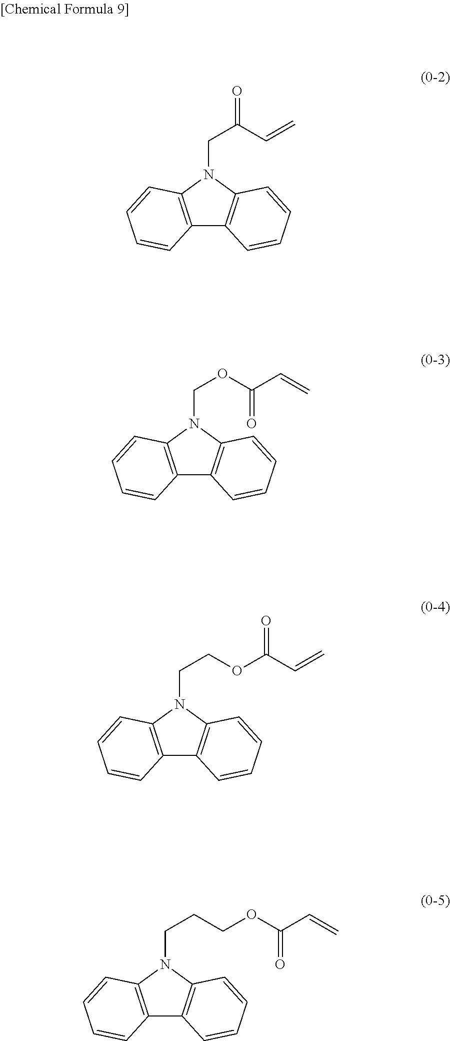 [SMILES: C=CC(=O)Cn1c2ccccc2c2ccccc21 ; C=CC(=O)OCn1c2ccccc2c2ccccc21 ; C=CC(=O)OCCn1c2ccccc2c2ccccc21 ; C=CC(=O)OCCCn1c2ccccc2c2ccccc21]

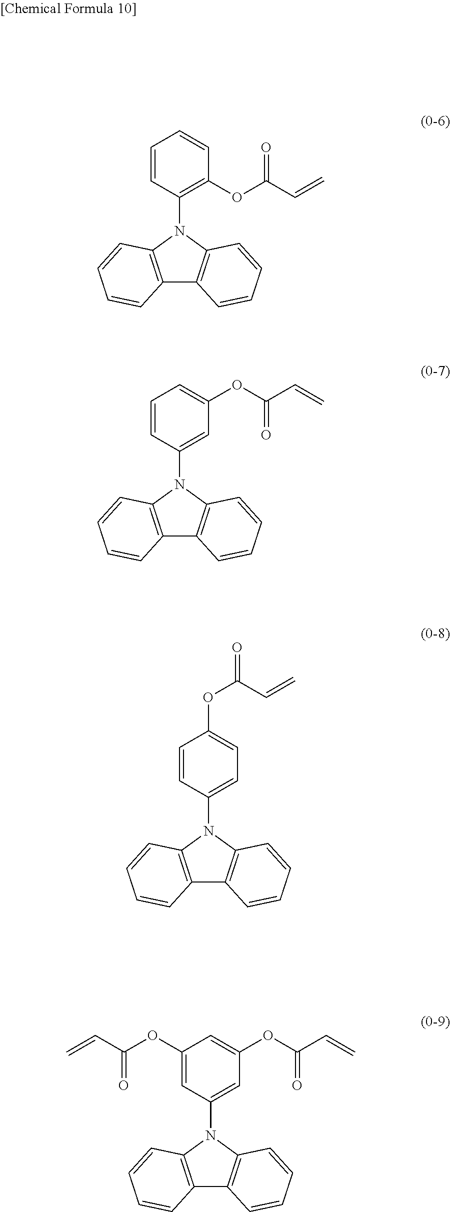

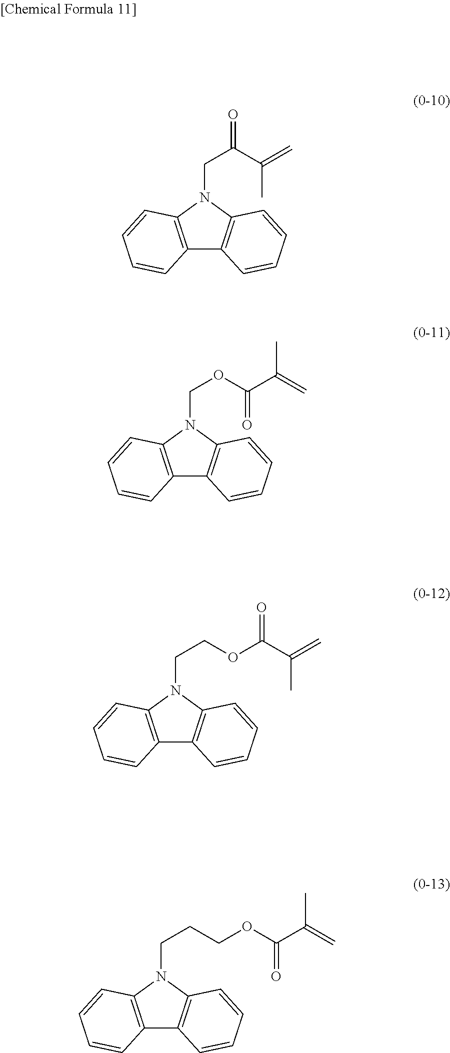 [SMILES: C=C(C)C(=O)Cn1c2ccccc2c2ccccc21 ; C=C(C)C(=O)OCn1c2ccccc2c2ccccc21 ; C=C(C)C(=O)OCCn1c2ccccc2c2ccccc21 ; C=C(C)C(=O)OCCCn1c2ccccc2c2ccccc21]

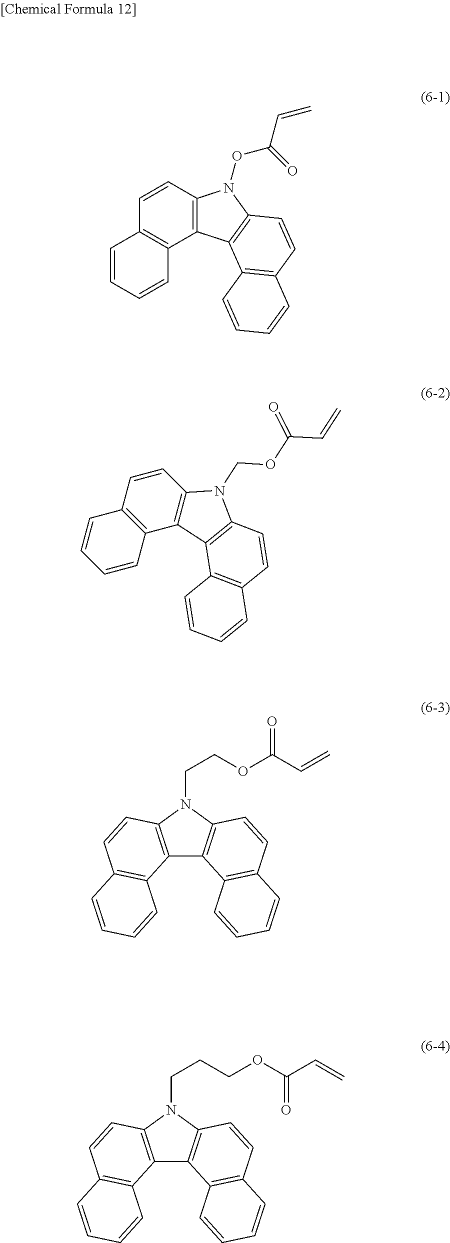 [SMILES: C=CC(=O)On1c2ccc3ccccc3c2c2c3ccccc3ccc21 ; C=CC(=O)OCn1c2ccc3ccccc3c2c2c3ccccc3ccc21 ; C=CC(=O)OCCn1c2ccc3ccccc3c2c2c3ccccc3ccc21 ; C=CC(=O)OCCCn1c2ccc3ccccc3c2c2c3ccccc3ccc21]

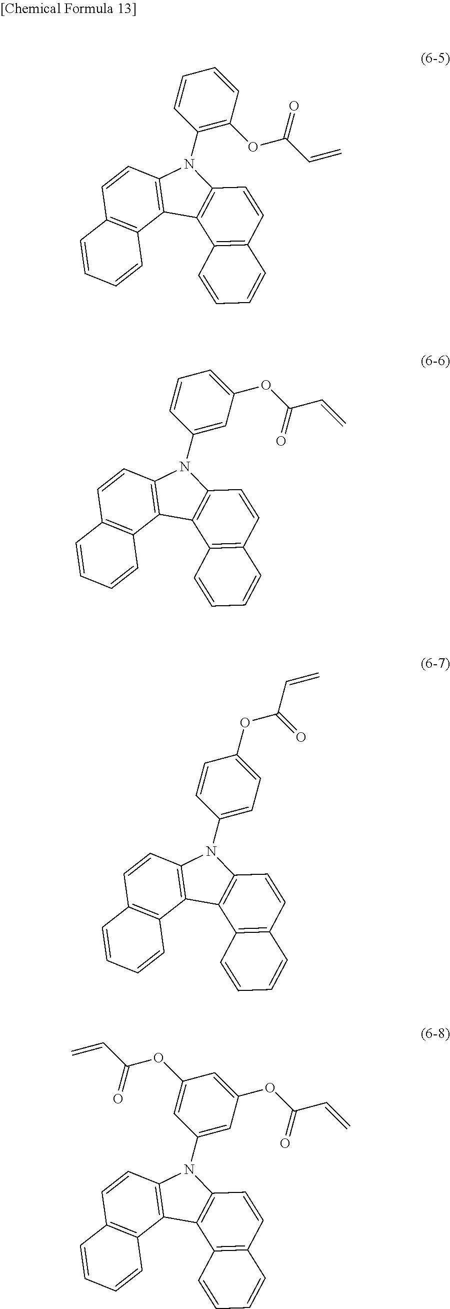

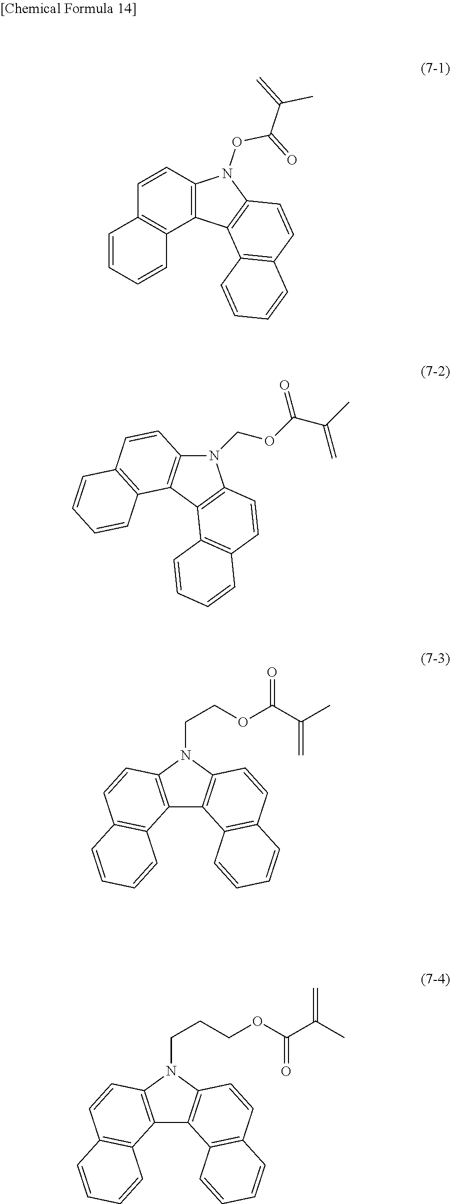 [SMILES: C=C(C)C(=O)On1c2ccc3ccccc3c2c2c3ccccc3ccc21 ; C=C(C)C(=O)OCn1c2ccc3ccccc3c2c2c3ccccc3ccc21 ; C=C(C)C(=O)OCCn1c2ccc3ccccc3c2c2c3ccccc3ccc21 ; C=C(C)C(=O)OCCCn1c2ccc3ccccc3c2c2c3ccccc3ccc21]

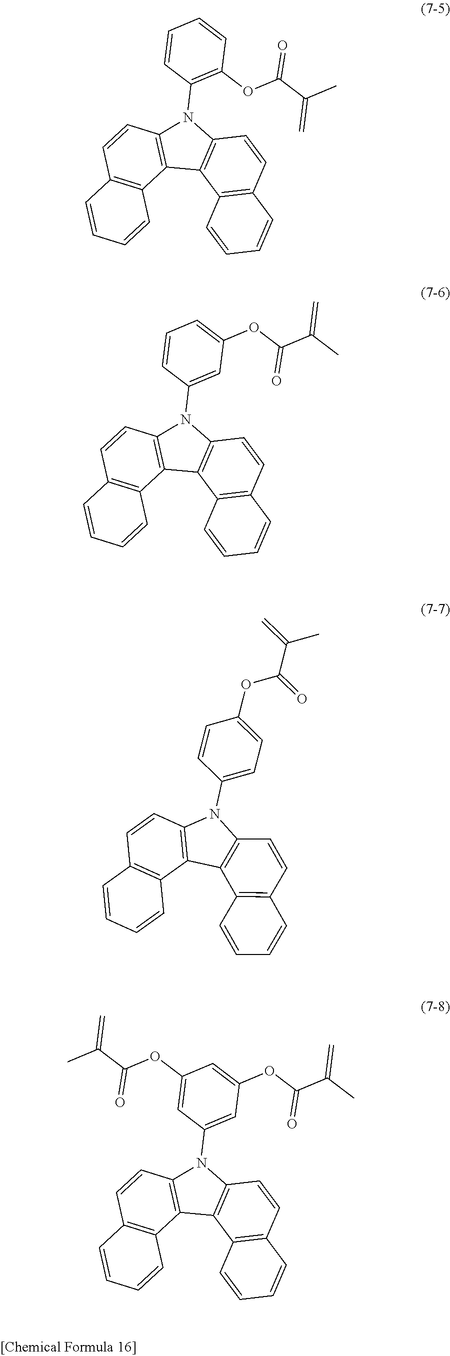

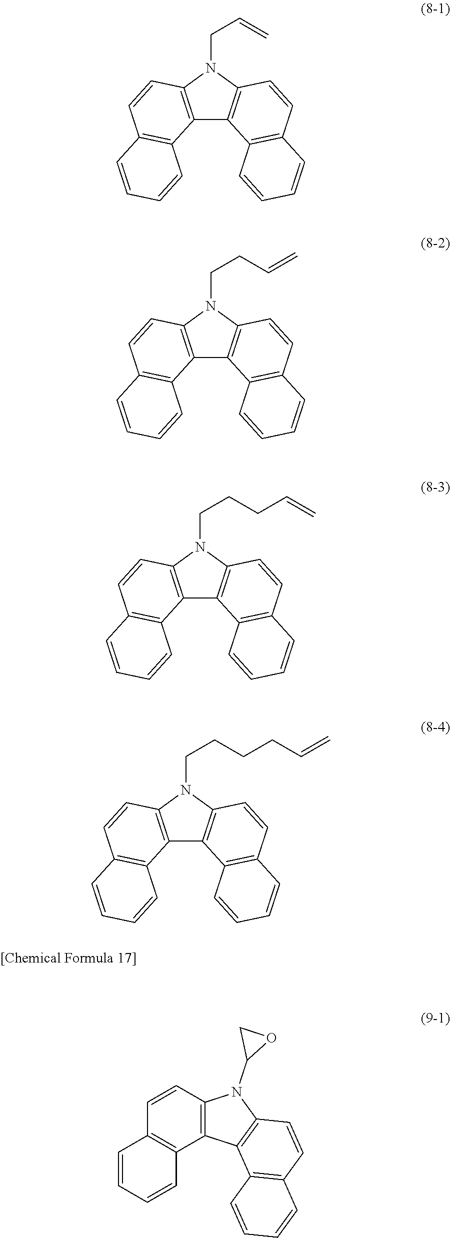 [SMILES: C=CCn1c2ccc3ccccc3c2c2c3ccccc3ccc21 ; C=CCCn1c2ccc3ccccc3c2c2c3ccccc3ccc21 ; C=CCCCn1c2ccc3ccccc3c2c2c3ccccc3ccc21 ; C=CCCCCn1c2ccc3ccccc3c2c2c3ccccc3ccc21 ; c1ccc2c(c1)ccc1c2c2c3ccccc3ccc2n1C1CO1]

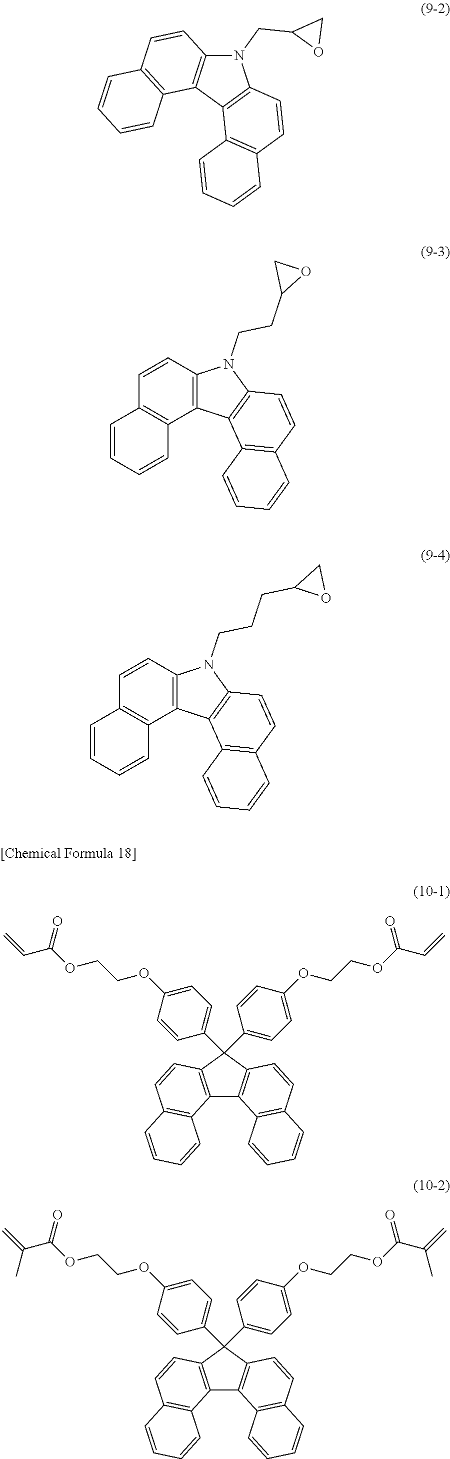

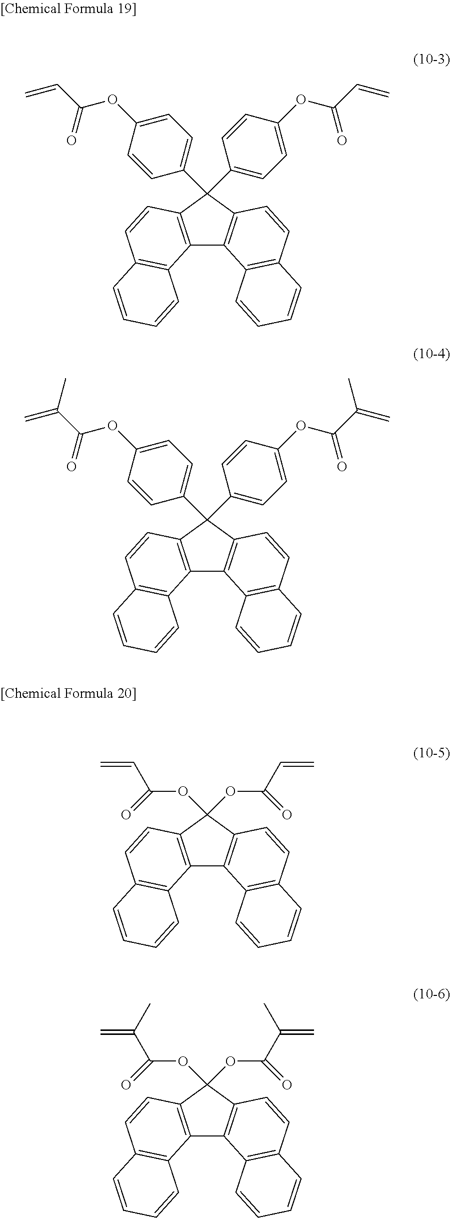

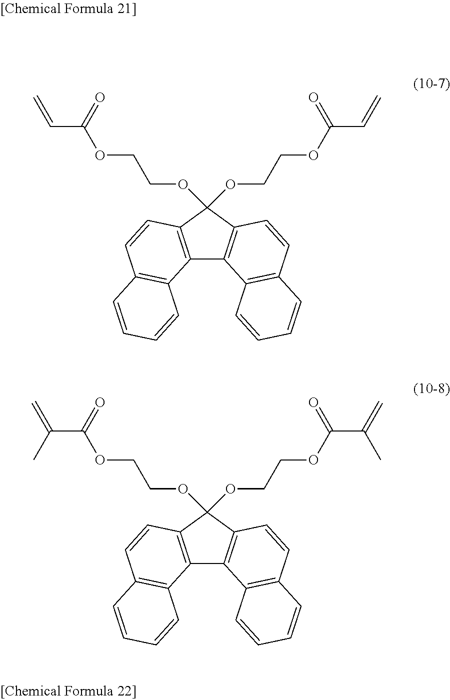

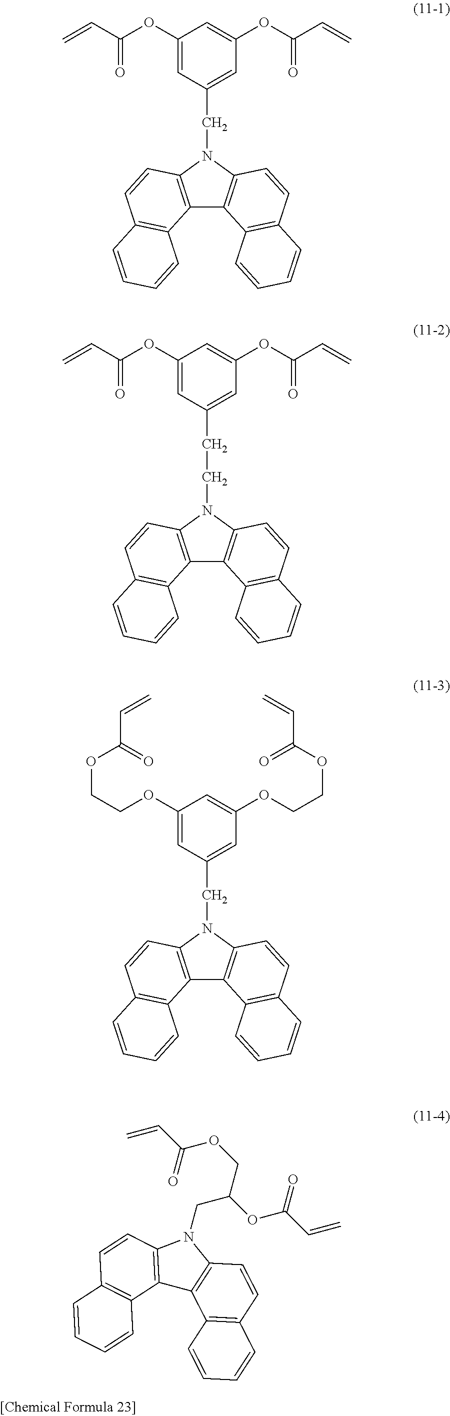

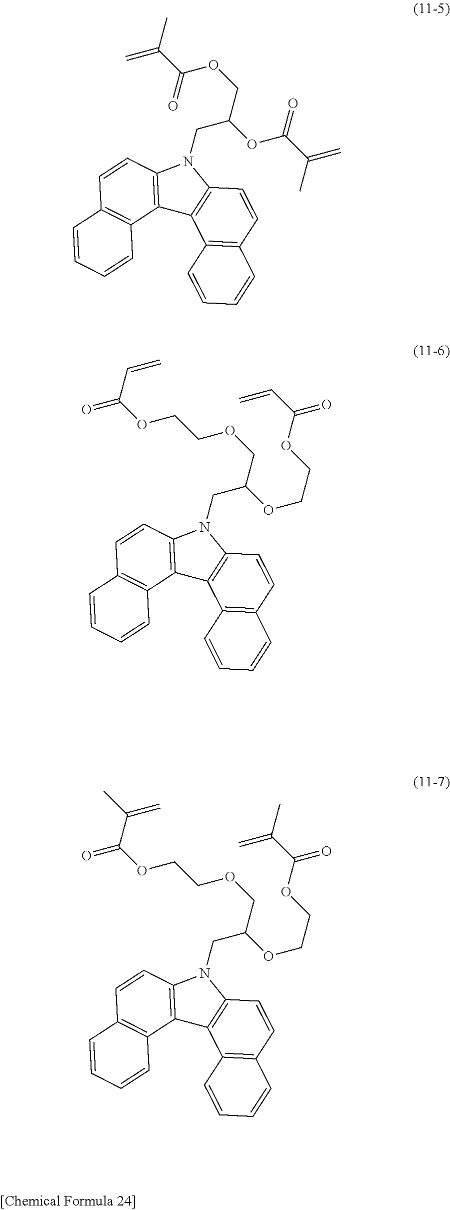 [SMILES: C=C(C)C(=O)OCC(Cn1c2ccc3ccccc3c2c2c3ccccc3ccc21)OC(=O)C(=C)C ; C=CC(=O)OCCOCC(Cn1c2ccc3ccccc3c2c2c3ccccc3ccc21)OCCOC(=O)C=C ; C=C(C)C(=O)OCCOCC(Cn1c2ccc3ccccc3c2c2c3ccccc3ccc21)OCCOC(=O)C(=C)C]

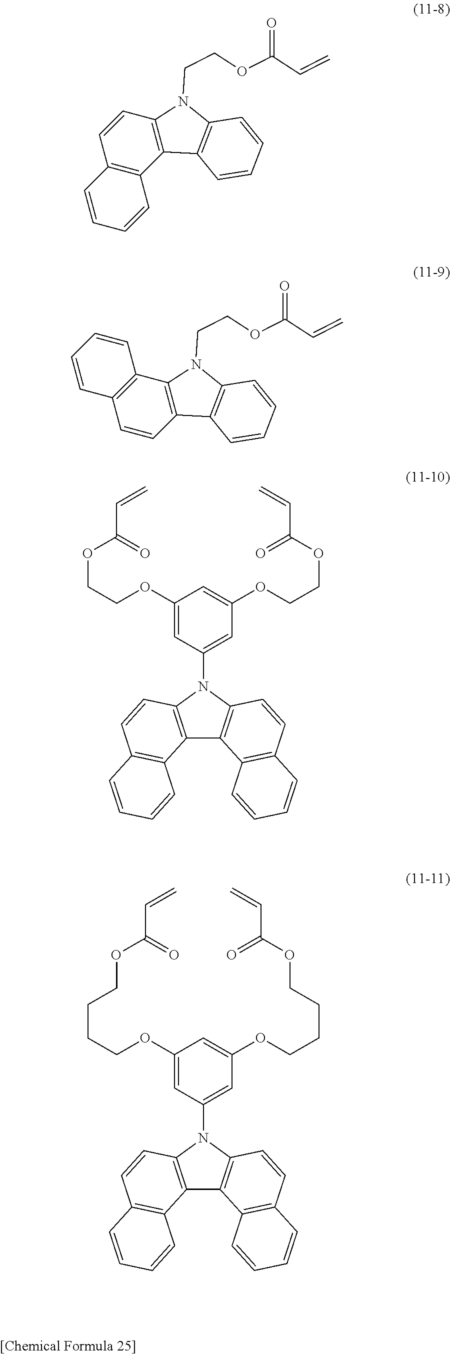 [SMILES: C=CC(=O)OCCn1c2ccccc2c2c3ccccc3ccc21 ; C=CC(=O)OCCn1c2ccccc2c2ccc3ccccc3c21 ; C=CC(=O)OCCOc1cc(OCCOC(=O)C=C)cc(-n2c3ccc4ccccc4c3c3c4ccccc4ccc32)c1 ; C=CC(=O)OCCCCOc1cc(OCCCCOC(=O)C=C)cc(-n2c3ccc4ccccc4c3c3c4ccccc4ccc32)c1]

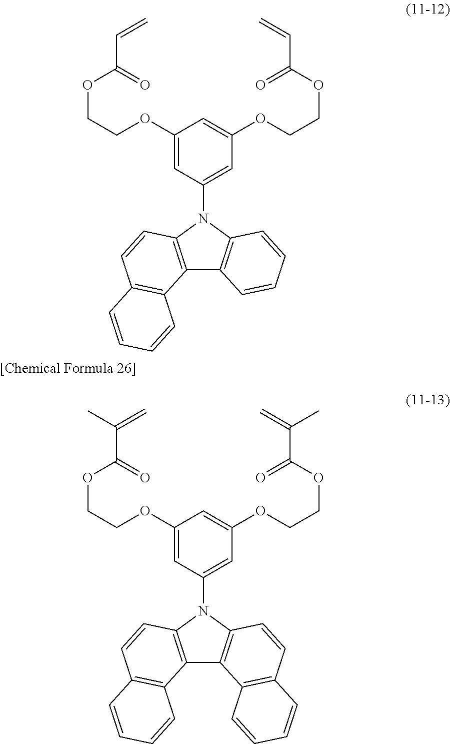 [SMILES: C=CC(=O)OCCOc1cc(OCCOC(=O)C=C)cc(-n2c3ccccc3c3c4ccccc4ccc32)c1 ; C=C(C)C(=O)OCCOc1cc(OCCOC(=O)C(=C)C)cc(-n2c3ccc4ccccc4c3c3c4ccccc4ccc32)c1]

The radical polymerizable organic monomer that can be contained in the composition according to the present technology may include, instead of the compound described above represented by General Formula (1) or together with the compound described above represented by General Formula (1), a polymerizable compound other than the compound. The polymerizable compound other than the above-described compound represented by General Formula (1) may include an aliphatic polymerizable compound.

In particular, in a case where the composition according to the present technology is used for a hologram used for reproduction of holography, the refractive index modulation degree Δn can be improved by using a monomer capable of achieving a high refractive index by polymerization.

The content of the radical polymerizable organic monomer that can be contained in the composition according to the present technology is not particularly limited, but if the radical polymerizable organic monomer is contained in an amount of, for example, 1% by mass or more, more preferably 10% by mass or more, and particularly preferably 20% by mass or more with respect to 100% by mass of the composition, a polymerization reaction occurs as a photochemical reaction by light energy transmitted from the sensitizing dye, and a polymer can be suitably produced.

The upper limit of the content of the radical polymerizable organic monomer that can be contained in the composition according to the present technology is not particularly limited, but can be suitably adjusted to, for example, 90% by mass or less, more preferably 80% by mass or less, and particularly preferably 60% by mass or less with respect to 100% by mass of the composition.

### <Binder Resin>

The composition according to the present technology may further include a binder resin. The “binder resin” contained in the composition according to the present technology is a polymer compound capable of suitably dispersing components included in the composition according to the present technology in the composition. Furthermore, the binder resin can be effective for improving the film strength and improving the heat resistance and the mechanical strength.

If the composition according to the present technology includes the binder resin, the concentration gradient generated with the progress of the polymerization reaction of the radical polymerizable organic monomer can be maintained, so that the interference fringes can be suitably recorded by a method such as irradiating the composition according to the present technology with interference light. Therefore, three-dimensional image information and the like can be suitably recorded, and thus, can be suitably used for applications such as holograms.

In addition, if the composition according to the present technology includes a binder resin, viscosity as a composition can be secured, so that a laminated film having a layer including the composition according to the present technology can be suitably manufactured by a method such as extrusion molding or coating.

The binder resin that can be contained in the composition according to the present technology is not particularly limited as long as it is a polymer compound having a low glass transition point (Tg) that can suitably disperse the components included in the composition in the composition.

The binder resin includes, for example, at least one selected from the group consisting of vinyl acetate-based resins such as polyvinyl acetate and its hydrolyzates; acrylic resins such as poly(meth)acrylic acid esters and partial hydrolyzates thereof; polyvinyl alcohol and its partial acetalized products; triacetyl cellulose; polyisoprene; polybutadiene; polychloroprene; silicone rubber; polystyrene; polyvinyl butyral; polychloroprene; polyvinyl chloride; polyarylate; chlorinated polyethylene; chlorinated polypropylene; poly-N-vinylcarbazole and its derivatives; poly-N-vinylpyrrolidone and its derivatives; polyarylate; copolymers of styrene and maleic anhydride and half-esters thereof; copolymers including at least one in the copolymerizable monomer group including acrylic acid, acrylic acid esters, methacrylic acid, methacrylic acid esters, acrylamide, acrylonitrile, ethylene, propylene, vinyl chloride, vinyl acetate, and the like as a polymerization component; and the like. Moreover, the binder resin may include, as the copolymerization component, a monomer containing a curable functional group that can be cured by heat or light.

The binder resin may include an oligomer-type curable resin. For example, the binder resin may include an epoxy compound produced by a condensation reaction of a phenol compound with epichlorohydrin, and the like. The phenol compound includes at least one selected from the group consisting of bisphenol A, bisphenol S, novolac, o-cresol novolac, p-alkylphenol novolac, and the like.

Regarding the polymer compound that can be used as the binder resin described above, the range of Tg can be adjusted so that the component can be suitably dispersed in accordance with the component of the composition according to the present technology.

The content of the binder resin that can be contained in the composition according to the present technology is not particularly limited, but if the binder resin is included in an amount of, for example, 1% by mass or more, more preferably 10% by mass or more, and particularly preferably 15% by mass or more based on 100% by mass of the composition, the components included in the composition can be suitably dispersed in the composition.

The upper limit of the content of the binder resin that can be contained in the composition according to the present technology is not particularly limited, and can be adjusted to an any range according to the components of the composition.

### <Polyalcohol>

The composition according to the present technology may further include a polyalcohol. The polyalcohol has a function as a color development stabilizer that stabilizes the color development of the sensitizing dye. The polyalcohol preferably includes a polyalcohol in a liquid state at normal temperature and normal pressure. If the polyalcohol includes the polyalcohol in a liquid state at normal temperature and normal pressure, dispersibility of the sensitizing dye in the composition can be improved. Furthermore, inhibition of mass transfer at the time of hologram recording can be suppressed. In the present specification, normal temperature and normal pressure refer to 25° C. and 1 atm.

The lower limit value of the valence of the polyalcohol (the number of hydroxy groups in the polyhydric alcohol molecule) is 2 or more. In a case where the valence of the polyalcohol is 2 or more, the volatility of the polyalcohol is reduced, so that in a case where a photosensitive layer is formed by a photosensitive composition, the polyalcohol can remain in the photosensitive layer.

The upper limit value of the valence of the polyalcohol (the number of hydroxy groups in the polyalcohol molecule) is not particularly limited, and is, for example, 6 or less, 7 or less, or 8 or less.

The lower limit value of the total number of carbon atoms of the polyalcohol is not particularly limited, and is, for example, 2 or more, 3 or more, 4 or more, 5 or more, or 6 or more. The upper limit value of the total number of carbon atoms of the polyalcohol is not particularly limited, and is, for example, 18 or less, 16 or less, 14 or less, 12 or less, or 10 or less.

The dihydric alcohol includes, for example, at least one selected from the group consisting of ethylene glycol, diethylene glycol, triethylene glycol, propylene glycol, dipropylene glycol, tripropylene glycol, pentaethylene glycol, hexaethylene glycol, heptaethylene glycol, octaethylene glycol, 1, 2-propanediol, 1,3-propanediol, 1,2-butanediol, 1,3-butanediol, 1,4-butanediol, 2, 3-butanediol, 2-methyl-1, 2-propanediol, 1,5-pentanediol, 2-methyl-2, 3-butanediol, 1,6-hexanediol, 1,2-hexanediol, 2, 5-hexanediol, 2-methyl-2, 4-pentanediol, 2,3-dimethyl-2, 3-butanediol, 2-ethyl-hexanediol, 1, 2-octanediol, 1,2-decanediol, 2, 2, 4-trimethylpentanediol, 2-butyl-2-ethyl-1,3-propanediol, 2,2-diethyl-1,3-propanediol, and the like.

The trihydric alcohol includes, for example, at least one selected from the group consisting of glycerin, trimethylolpropane, trimethylolethane, triethylolethane, and the like.

The tetrahydric alcohol includes, for example, at least one selected from the group consisting of diglycerin, ditrimethylolpropane, pentaerythritol, dipentaerythritol, D-threitol, and the like.

The pentahydric alcohol includes, for example, at least one selected from the group consisting of L-arabinitol, ribitol, xylitol, L-rhamnitol, and the like.

The hexahydric alcohol includes, for example, at least one selected from the group consisting of D-glucitol, D-mannitol, galactitol, and the like.

The heptahydric alcohol includes, for example, at least one selected from the group consisting of pentaglycerin, heptitol, and the like.

The octahydric alcohol includes, for example, at least one selected from the group consisting of sucrose, trehalose, maltose, gentiobiose, lactose, melibiose, and the like.

### <Inorganic Fine Particles>

The composition according to the present technology may further include inorganic fine particles. The inorganic fine particles include, for example, metal oxide fine particles. The metal oxide fine particles include, for example, at least one selected from the group consisting of titanium oxide (TiOₓ) fine particles and zirconium oxide (ZrOₓ) fine particles. The photosensitive composition may include one kind of inorganic fine particles or two or more kinds of inorganic fine particles. Specifically, for example, the photosensitive composition may include both titanium oxide fine particles and zirconium oxide fine particles.

### <Chain Transfer Agent>

The composition according to the present technology may further include a chain transfer agent. The chain transfer agent extracts a radical from the growth terminal of the polymerization reaction to stop the growth, and serves as a new polymerization reaction-initiating species to be add to the radical polymerizable monomer, and thus can start the growth of a new polymer. If the composition according to the present technology includes the chain transfer agent, the frequency of chain transfer of radical polymerization is increased, so that the reaction rate of the radical polymerizable monomer increases, and the sensitivity to light can be improved. Furthermore, increase in the reaction rate of the radical polymerizable monomer increases components contributing to the reaction, and thus the degree of polymerization of the radical polymerizable monomer can be adjusted.

The chain transfer agent includes, for example, at least one selected from the group consisting of α-methylstyrene dimer, 2-mercaptobenzoxazole, 2-mercaptobenzothiazole, tert-butyl alcohol, n-butanol, isobutanol, isopropylbenzene, ethylbenzene, chloroform, methyl ethyl ketone, propylene, vinyl chloride, and the like.

### <Polymerization Inhibitor>

The composition according to the present technology may further include a polymerization inhibitor. The polymerization inhibitor can be effective for suppressing occurrence of unnecessary polymerization of the polymerizable compound and the like due to light, heat, and the like. The polymerization inhibitor includes, for example, at least one selected from the group consisting of a quinone-based compound (for example, hydroquinone), a hindered phenol-based compound, a benzotriazole-based compound, a thiazine-based compound (for example, phenothiazine), and the like.

### <UV Sensitizing Dye>

The composition according to the present technology may further include a UV sensitizing dye. The UV sensitizing dye is effective for absorbing UV light and improving the curing speed, cured product characteristics, and the like of the composition, and can accelerate the polymerization reaction of the polymerizable monomer and the radical polymerizable organic monomer remaining as monomers in the composition at the time of UV exposure and the like as described later. The UV sensitizing dye includes, for example, an anthracene-based compound and the like.

### <Solvent>

The composition according to the present technology may include a solvent. The solvent can be effective for adjusting the viscosity and improving the film-formability and the like. The solvent includes, for example, at least one selected from the group consisting of acetone, xylene, toluene, methyl ethyl ketone, tetrahydrofuran, benzene, methylene chloride, dichloromethane, chloroform, methanol, ethanol, and the like.

### <Other Components>

The composition according to the present technology may contain other components in addition to those described above, as necessary, as long as desired various physical properties are not significantly impaired. One kind of them components may be contained, or two or more kinds thereof may be contained in any combinations and ratios.

### 2. Second Embodiment

### [Laminated Film]

The laminated film according to the present technology includes one or more layers including the composition according to the present technology. By using the composition according to the present technology as a layer of a laminated film, for example, it can be efficiently used and the like when necessary.

Here, in the present specification, the “film” refers to a molded body molded into a film shape having an any thickness, and also includes a so-called sheet.

### <Substrate Layer>

The laminated film according to the present technology may include a substrate layer, a resin layer, and a release layer in this order, and the resin layer may include the composition according to the present technology.

The “substrate layer” included in the laminated film according to this embodiment is a layer that can secure the strength of the entire laminated film according to the use of the laminated film, and a laminated film having a function according to the use can be manufactured by laminating a layer having various functions such as a resin layer including the composition according to the present technology on one or both surfaces of the substrate layer. Furthermore, the substrate layer can also function as a protective layer for protecting layers having various functions.

In the laminated film according to the present technology, the material for forming the substrate layer is not particularly limited as long as it is a material that can secure the strength of the entire laminated film according to the use application of the laminated film, but for example, from the viewpoint of recording interference fringes and the like, it is preferable to use a material having high light transmittance and low oxygen transmittance. Here, as the material having low oxygen permeability, for example, a material is assumed in which the oxygen permeability measured in an environment of 23° C. and 0% RH is more than 0.1 cm³·(m²·day·atm)⁻¹ and 10,000 cm³·(m²·day·atm)⁻¹ or less. As an example of such a material, for example, a polymer compound such as a cycloolefin-based resin such as a cycloolefin polymer (COP), a polycarbonate-based resin, a polyester-based resin, or a cellulose-based resin can be suitably used. The substrate layer may be a layer including a single compound or a layer including a composition including a plurality of compounds.

In a case where the base material layer includes two or more compounds, the two or more compounds may be mixed, the two or more compounds may be copolymerized, or the two or more compounds may be laminated to form a laminated film.

The above-described cycloolefin-based resin includes, for example, at least one selected from the group consisting of a norbornene-based polymer, a vinyl alicyclic hydrocarbon polymer, a cyclic conjugated diene polymer, and the like. Among them, it is preferable to include a norbornene-based polymer. The norbornene-based polymer includes, for example, at least one selected from the group consisting of a ring-opened polymer of a norbornene-based monomer, a norbornene-based copolymer obtained by copolymerizing a norbornene-based monomer and an α-olefin such as ethylene, and the like. The polycarbonate-based resin includes, for example, at least one selected from the group consisting of an aliphatic polycarbonate-based resin, an aromatic polycarbonate-based resin, and the like. Examples of the polyester-based resin include, for example, a polyethylene terephthalate-based resin and the like. Examples of the cellulose-based resin include an acetyl cellulose-based resin. The acetyl cellulose-based resin includes at least one selected from the group consisting of triacetyl cellulose (TAC), diacetyl cellulose, and the like.

In the laminated film according to the present technology, the thickness of the substrate layer can be appropriately selected to any thickness according to the use of the laminated film, but is preferably 0.1 μm or more, more preferably 1 μm or more, and still more preferably 3 μm or more from the viewpoint of transparency and rigidity of the hologram recording medium 10. The upper limit of the thickness of the substrate layer is not particularly limited, but can be suitably adjusted within a range of, for example, 200 μm or less, more preferably 150 μm or less, and still more preferably 70 μm or less.

The base material layer may include a coat-treated layer as necessary. The coat-treated layer may be provided on both of a first surface and a second surface of the base material layer or on one surface of the base material layer. The coat-treated layer includes, for example, an ultraviolet curable resin. The coat-treated layer may include an additive such as fine particles as necessary.

### <Release Layer>

The “release layer” included in the laminated film according to the present technology is a layer that is provided on a surface side of the resin layer including the composition according to the present technology on a side opposite to a surface on which the substrate layer is present in the laminated film, and releases and separates the resin layer from a portion including the resin layer of the laminated film when the resin layer is bonded to a surface of a member. Note that the release layer can also function as a protective layer that protects a layer having various functions such as a resin layer included in the laminated film before release.

In the laminated film according to the present technology, the material for forming the release layer is not particularly limited as long as it is a material that can be released from a predetermined interface in the laminated film when the resin layer is bonded to the surface of the member, but from the viewpoint of protecting the resin layer including the composition for recording interference fringes, for example, it is preferable to use a material having oxygen permeability that satisfies the above-described conditions. As an example of such a material, for example, a cycloolefin-based resin, a polycarbonate-based resin, a polyester-based resin, and the like can be suitably used. The release layer may be a layer including a single compound or a layer including a composition including a plurality of compounds.

In the laminated film according to the present technology, as the thickness of the release layer, an any thickness can be appropriately selected according to the use of the laminated film.

### <Resin Layer>

The “resin layer” included in the laminated film according to the present technology is a layer including the composition according to the present technology.

In the laminated film according to the present technology, the thickness of the resin layer can be appropriately selected to be any thickness according to the use of the laminated film, and is preferably 0.1 μm or more, more preferably 1 μm or more from the viewpoint of diffraction efficiency and sensitivity to light. The upper limit of the thickness of the resin layer is not particularly limited, but can be suitably adjusted within a range of, for example, 100 μm or less, more preferably 30 μm or less.

In the laminated film according to the present technology, the resin layer can also be formed by, for example, applying the prepared composition according to the present technology onto the base material layer and then drying the composition. As the coating method, for example, a spin coater, a gravure coater, a slot die, a comma coater, a bar coater, and the like can be used.

### <Adhesive Layer>

The laminated film according to the present technology may further include an adhesive layer. Here, the “adhesive layer” is a layer that exists between any two layers (interface and the like) included in the laminated film and enables two layers to adhere.

In the laminated film according to the present technology, the position of the adhesive layer is not limited, and the adhesive strength of the two layers can be enhanced by providing the adhesive layer between any two layers. In addition, for example, by providing an adhesive layer at the interface between the resin layer and the release layer, the release layer can be released at the interface between the release layer and the adhesive layer to be separated from the laminated film, and then the exposed adhesive layer can be suitably bonded to the surface of an any member.

In the laminated film according to the present technology, as the material for forming the adhesive layer, a material that can suitably adhere each material can be selected in accordance with the characteristics of the material constituting the two layers to be reinforced in adhesive strength and the characteristics of the material constituting the member surface to be subjected to the adhesion. The adhesive layer may be a layer including a single compound or a layer including a composition including a plurality of compounds.

In the laminated film according to the present technology, as the thickness of the adhesive layer, an any thickness can be appropriately selected in accordance with the characteristics of the material constituting the two layers to be reinforced in adhesive strength.

### <Other Layers>

The laminated film according to the present technology may include other layers in addition to the layers described above as necessary as long as desired various physical properties are not significantly impaired.

Hereinafter, specific embodiments of the laminated film and the like according to the present technology will be described with reference to the drawings. Note that the following embodiments are examples of embodiments of the present technology, and the present technology is not to be construed as being limited to the contents of these embodiments at all.

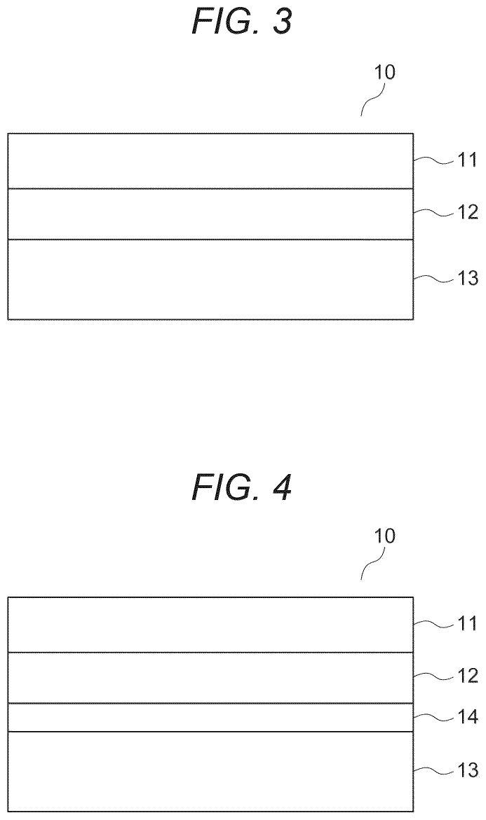

FIG. 3 is a view illustrating an example of the laminated film according to the present technology, and the laminated film 10 includes a resin layer 12 provided on one surface of a substrate layer 11 and a release layer 13 provided on a surface of the resin layer 12 on a side opposite to a surface in contact with the substrate layer 11.

In the laminated film of the present embodiment, when the resin layer 12 is bonded to the surface of an any member, at the interface between the resin layer 12 and the release layer 13, the release layer 13 is separated from the portion of the laminated film 10 including the resin layer 12.

FIG. 4 is a view showing a modification of the laminated film according to the present technology, and shows a form in which an adhesive layer 14 is provided at an interface between a resin layer 12 and a release layer 13 of the laminated film shown in FIG. 3.

In the laminated film of the present embodiment, when the resin layer 12 is bonded to the surface of an any member, at the interface between the adhesive layer 14 and the release layer 13, the release layer 13 is separated from the portion of the laminated film 10 including the resin layer 12. Therefore, the laminated film 10 including the resin layer 14 can be suitably bonded to the surface of an any member by the exposed adhesive layer 14.

### 3. Third Embodiment

### [Hologram Recording Medium]

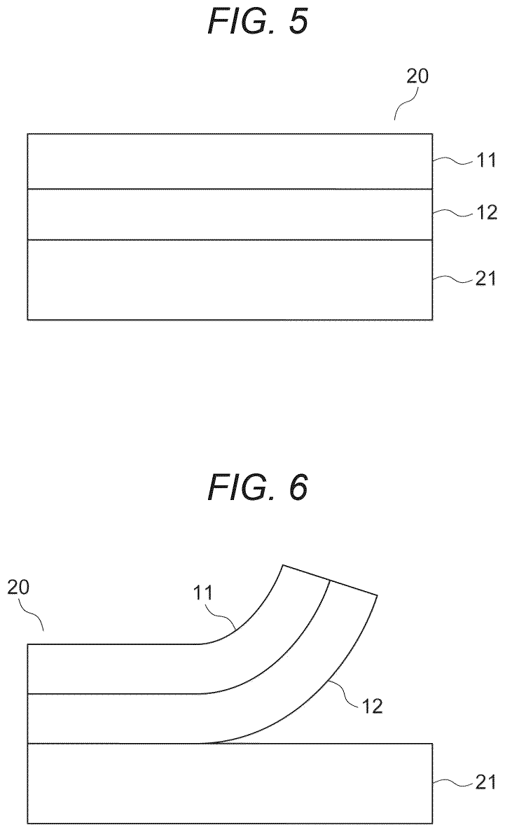

FIG. 5 is a cross-sectional view illustrating an example of a configuration of an optical member 20 according to a third embodiment. The optical member 20 which is a hologram recording medium is a volume hologram recording medium and includes a member main body 21 and a resin layer 12.

### (Member Main Body)

The member main body 21 is for supporting the resin layer 12. The member main body 21 also has a function as a protective layer for protecting the resin layer 12. The member main body 21 has transparency to visible light. The member main body 21 may be a film or a substrate having rigidity. Examples of the material for forming the substrate having rigidity include, but are not limited to, for example, a material such as glass.

The member main body 21 is formed by, for example, a composition including a compound such as a polymer material. The polymer material includes, for example, at least one selected from the group consisting of cycloolefin-based resins, polycarbonate-based resins, polyester-based resins, and cellulose-based resins. In a case where the member main body 21 includes two or more resins, the two or more resins may be mixed, copolymerized, or laminate to form a laminated film.

The cycloolefin-based resin includes, for example, at least one selected from the group consisting of a norbornene-based polymer, a vinyl alicyclic hydrocarbon polymer, a cyclic conjugated diene polymer, and the like. Among them, it is preferable to include a norbornene-based polymer. The norbornene-based polymer includes, for example, at least one selected from the group consisting of a ring-opened polymer of a norbornene-based monomer, a norbornene-based copolymer obtained by copolymerizing a norbornene-based monomer and an α-olefin such as ethylene, and the like. The polycarbonate-based resin includes, for example, at least one selected from the group consisting of an aliphatic polycarbonate-based resin, an aromatic polycarbonate-based resin, and the like. Examples of the polyester-based resin include, for example, a polyethylene terephthalate-based resin and the like. Examples of the cellulose-based resin include an acetyl cellulose-based resin. The acetyl cellulose-based resin includes at least one selected from the group consisting of triacetyl cellulose (TAC), diacetyl cellulose, and the like.

The thickness of the member main body 21 may be appropriately set by those skilled in the art, but is preferably 0.1 μm or more and 200 μm or less, more preferably 1 μm or more and 150 μm or less, and still more preferably 3 μm or more and 70 μm or less from the viewpoint of transparency and rigidity of the optical member 20.

The member main body 21 may include a coat-treated layer as necessary. The coat-treated layer may be provided on both of a first surface and a second surface of the member main body 21 or on one surface of the base material layer. The coat-treated layer includes, for example, an ultraviolet curable resin. The coat-treated layer may include an additive such as fine particles as necessary.

### (Resin Layer)

The resin layer 12 includes the composition according to the first embodiment.

The thickness of the resin layer 12 may be appropriately set by those skilled in the art, but is preferably 0.1 μm or more and 100 μm or less, and more preferably 1 μm or more and 30 μm or less from the viewpoint of diffraction efficiency and sensitivity to light.

### [Method for Manufacturing Optical Member]

Hereinafter, an example of a method for manufacturing the optical member 20 according to the third embodiment will be described.

### (Preparation of Composition)

First, a composition is prepared as in a manner similar to that in the first embodiment.

### (Step of Forming Resin Layer)

Next, the prepared composition is applied onto the member main body 21, and then dried to form the resin layer 12. As the coating method, for example, a spin coater, a gravure coater, a comma coater, a bar coater, and the like can be used. As described above, the intended optical member 20 can be obtained.

### [Modification]

The optical member 20 may further include a release layer 13, similar to the form of the laminated film as shown in FIG. 3. The release layer 13 is provided on an outer surface opposite to the member main body 21 out of both surfaces of the resin layer 12. The release layer 13 is configured to be peelable from the resin layer 12. The release layer 13 may be a film or a substrate having rigidity, but is preferably a film from the viewpoint of increasing the oxygen permeability of the member main body 21.

FIG. 6 is a view illustrating an example in which the resin layer is released from the member main body 12 in the member illustrated in FIG. 5. In this mode, releasing progresses at the interface between the resin layer 12 and the member main body 21.

After a hologram and the like is produced by exposure for recording interference fringes and the like, the resin layer 12 as a hologram is released from the member main body 21, so that the film can be used as a form of a film. Furthermore, thereafter, the film can be cut into an any shape and used.

Furthermore, after a hologram and the like is created by exposure for recording interference fringes and the like using a planar member as the member main body of the member according to the present technology, the resin layer released from the member main body can be transferred to the curved member.

The optical member 20 according to the third embodiment can be manufactured, for example, by the following method.

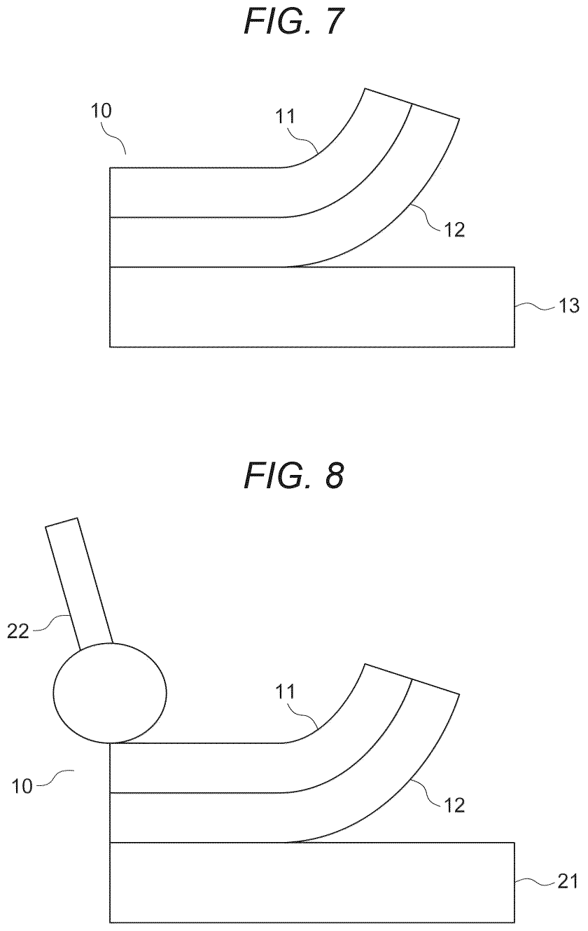

FIG. 7 is a releasing step in a method for manufacturing the member according to the present technology using the laminated film according to the present technology. Release layer 13 is separated by releasing at an interface between resin layer 12 and release layer 13 of laminated film 10.

FIG. 8 is a bonding step in a method for manufacturing the member according to the present technology using the laminated film according to the present technology. The laminated film 10 from which the above-described release layer 13 is separated is bonded to the surface of the member main body 21. At this time, by using an adhesion assisting tool such as a roller or a bonding device, it is possible to suppress generation of bubbles and wrinkles due to air and the like on the adhesion surface between the member main body 21 and the resin layer 12.

The adhesion assisting tool used at this time is not particularly limited, but for example, any bonding device such as a hand roller (HAL-TEC (HAL320) manufactured by Sankyo Co., Ltd.) can be suitably used.

### 4. Fourth Embodiment

### [Configuration of Hologram Optical Element]

The optical member according to the hologram optical element according to the fourth embodiment is a volume hologram optical element, and is obtained by exposing the optical member 20. The hologram optical element includes an exposed resin layer 12, that is, a hologram layer. The polymerizable compound contained in the exposed resin layer 12 is polymerized. The exposed resin layer 12 may include, for example, a polymer and/or an oligomer including a constituent unit derived from a compound represented by General Formula (1) described above and a polymerization initiator having a structure changed by irradiating the polymerization initiator with external energy to generate an active species.

The member according to the present technology after exposure for recording interference fringes and the like includes a resin layer on at least a part of the surface, and the resin layer includes a sensitizing dye in which an absorption wavelength of light reversibly changes or a derivative of the sensitizing dye, a polymer of a polymerizable monomer, and an absorption wavelength maintaining agent.

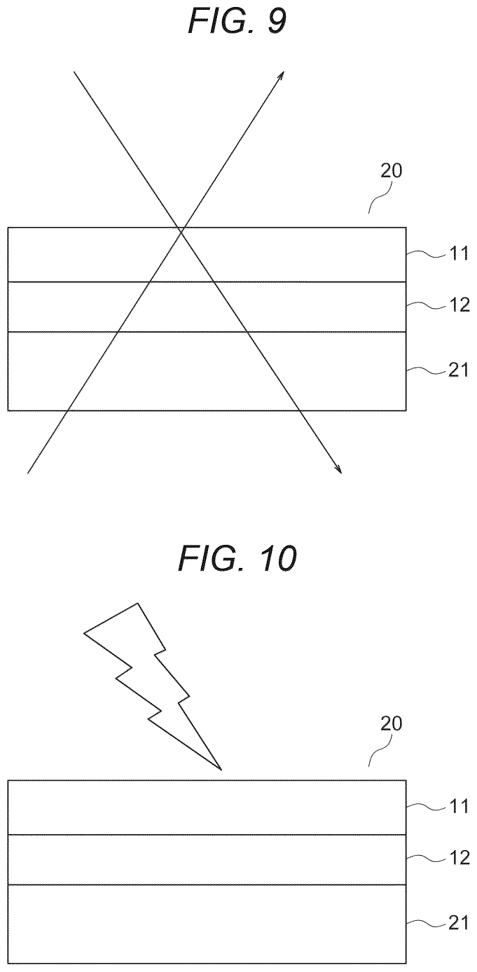

FIG. 9 is an interference exposure step in a method of manufacturing the member according to the present technology using the laminated film according to the present technology.

### [Optical System for Hologram Recording]

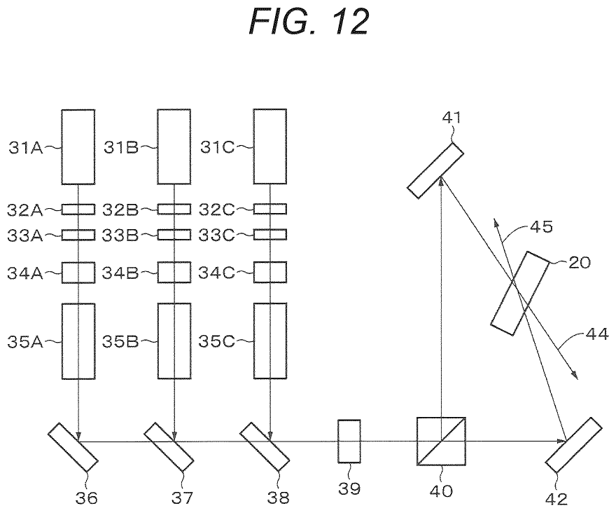

FIG. 12 is a schematic view illustrating an example of a configuration of a hologram recording optical system used for exposure of the optical member 20. The optical system for hologram recording includes a diode-pumped solid-state laser 31A, a diode-pumped solid-state laser 31B, a diode-pumped solid-state laser 31C, electron shutters 32A, 32B, and 32C, half-wave plates 33A, 33B, and 33C, objective lenses 34A, 34B, and 34C, beam expanders 35A, 35B, and 35C, a mirror 36, a dichroic mirror 37, a dichroic mirror 38, an iris diaphragm 39, a beam splitter 40, a mirror 41, and a mirror 42.

The diode-pumped solid-state laser 31A emits red laser light having a peak wavelength of 660 nm. The red laser light emitted by the diode-pumped solid-state laser 31A is incident on the mirror 36 via the electron shutter 32A, the half-wave plate 33A, the objective lens 34A, and the beam expander 35A. The red laser light reflected by the mirror 36 is incident on the beam splitter 40 via the dichroic mirror 37, the dichroic mirror 38, and the iris diaphragm 39.

The diode-pumped solid-state laser 31B emits green laser light having a peak wavelength of 532 nm. The green laser light emitted by the diode-pumped solid-state laser 31B is incident on the dichroic mirror 37 via the electron shutter 32B, the half-wave plate 33B, the objective lens 34B, and the beam expander 35B. The dichroic mirror 37 reflects green laser light but transmits red laser light. The green laser light reflected by the dichroic mirror 37 is incident on the beam splitter 40 via the dichroic mirror 38 and the iris diaphragm 39.

The diode-pumped solid-state laser 31C emits blue laser light having a peak wavelength of 460 nm. The blue laser light emitted by the diode-pumped solid-state laser 31C is incident on the dichroic mirror 38 via the electron shutter 32C, the half-wave plate 33C, the objective lens 34C, and the beam expander 35C. The dichroic mirror 38 reflects blue laser light but transmits red laser light and green laser light. The blue laser light reflected by the dichroic mirror 38 is incident on the beam splitter 40 via the iris diaphragm 39.

Each color laser light incident on the beam splitter 40 is separated into a first light flux 44 and a second light flux 45. The separated first light flux 44 and second light flux 45 are reflected by the mirror 41 and the mirror 42, respectively, and thus the optical member 20 is irradiated with the first light flux 44 and the second light flux 45.

The member 20 is irradiated with interference light. Therefore, in the resin layer 12 including the composition according to the present technology, the energy of light absorbed by the sensitizing dye is transmitted to a reactant such as a polymerization initiator or a radical polymerizable organic monomer according to the irradiation amount of light, and the polymerization reaction of the radical polymerizable organic monomer proceeds. On the other hand, since the polymerization reaction does not proceed in a region where the irradiation amount of light is small, a concentration gradient of the polymer of the radical polymerizable organic monomer occurs, and a phase separation structure is formed inside the resin layer 12.

By the formation of the phase separation structure, the refractive index difference between the separated phases in the resin layer 12 increases, and the refractive index modulation degree Δn is improved.

Note that the conditions of two light fluxes exposure at the time of irradiation with interference light may be appropriately set by those skilled in the art according to the application, purpose, and the like of the hologram optical element. For example, the light intensity of the single light flux on the hologram recording medium is set to 0.1 mW/cm² or more and 100 mW/cm² or less, and the exposure condition for 1 second or more and 1000 seconds or less can be appropriately adjusted. In addition, interference exposure can be performed such that the angle formed by the two light fluxes is 0.1 degrees or more and 179.9 degrees or less.

FIG. 10 is a UV exposure step in a method of manufacturing the member according to the present technology using the laminated film according to the present technology.

In this step, the entire member 20 subjected to the interference exposure is irradiated with UV. The polymerization initiator is excited by UV irradiation, and the polymerization reaction of the polymerizable monomer proceeds. As the polymerization reaction proceeds, the phase separation structure formed inside the resin layer 12 is fixed, and the interference fringes generated by the interference light can be suitably recorded.

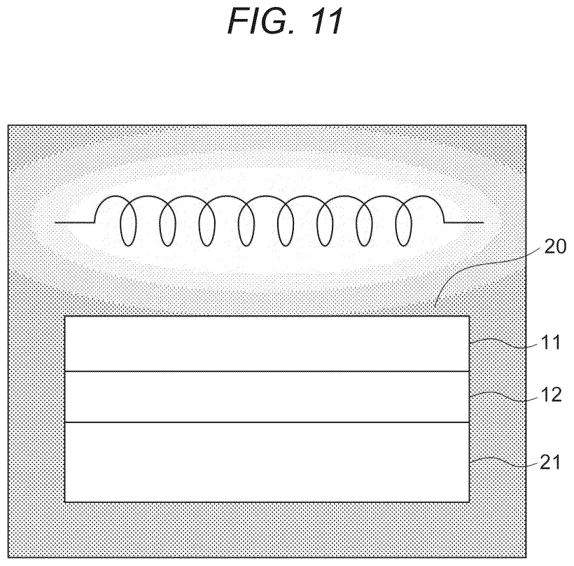

FIG. 11 is a heating step in the method for manufacturing the member according to the present technology using the laminated film according to the present technology.

In this step, the entire member 20 subjected to the UV exposure is heated to promote the polymerization reaction of the unreacted radical polymerizable organic monomer and polymerizable monomer, so that the radical polymerizable organic monomer and the polymerizable monomer are diffused inside the resin layer 12. As a result, further phase separation proceeds by the polymerization reaction using the existing phase separation structure as a nucleus, so that the refractive index difference between the phases further increases and the refractive index modulation degree Δn is improved.

### 5. Fifth Embodiment

### [Optical Device and Optical Component]

The hologram using the member according to the present technology obtained by the method described above and the like can be suitably used as an optical device, an optical component, and the like. Examples of the optical device and the optical component include an image display device such as eyewear, a holographic screen, a transparent display, a head-mounted display, and a head-up display, an imaging device, an imaging element, a color filter, a diffractive lens, a light guide plate, a spectral element, a hologram sheet, an information recording medium such as an optical disk and a magneto-optical disk, an optical pickup device, a polarizing microscope, and a sensor.

The optical device and the optical component using the hologram using the member according to the present technology according to the present technology can achieve excellent diffraction characteristics and transparency. Therefore, it is possible to achieve an optical device and an optical component having high optical characteristics and high optical stability. Furthermore, in a case where the present disclosure is used for a display, it is possible to provide a display having a high see-through property.

### 6 Sixth Embodiment

### [Method for Forming Hologram Diffraction Grating]

The present embodiment provides a method for forming a hologram diffraction grating, in which an optical member 20 including a resin layer 12 including a sensitizing dye, a polymerizable monomer, an absorption wavelength maintaining agent, a radical polymerizable organic monomer including the compound represented by the General Formula (1) described above, a binder resin, and a polymerization initiator is caused to selectively react with the resin layer 12 by an electromagnetic ray in which intensity of amplitude is spatially modulated, and interference fringes can be suitably recorded. The method for forming a hologram diffraction grating is the interference exposure described in the above-described fourth embodiment. Therefore, description of the method for forming a hologram diffraction grating is omitted. According to the method for forming a hologram diffraction grating, effects as described in the fourth embodiment are obtained. Here, the “electromagnetic rays” are waves propagating through changes in an electric field and a magnetic field, and include radio waves, infrared rays, visible rays, ultraviolet rays, X-rays, and the like.

### 7 Seventh Embodiment

The composition according to the present technology can also be suitably used as an adhesive or a sealant.

### [Adhering Method/Sealing Method]

Since the composition according to the present technology can cause a polymerization reaction of the polymerizable monomer by photosensitizing with the contained sensitizing dye, the composition can be cured using light having a long wavelength by a combination of the sensitizing dye and the polymerizable monomer to be used.

Therefore, for example, it is possible to use such that curing is performed to a deep portion that cannot be reached by short-wavelength light such as UV.

Furthermore, in the composition according to the present technology, the sensitizing dye and the polymerizable monomer react by a reaction as shown in FIG. 15 by the irradiation of the above-described light, and the absorption wavelength of the sensitizing dye is fixed, so that the color of the reacted portion can be decolored. Therefore, in a case where the composition according to the present technology is used as an adhesive or a sealant, the validity of the application position and the presence or absence of protrusion can be visually confirmed, and the application position can be made inconspicuous by decoloring after curing.

In addition, since the composition according to the present technology contains an absorption wavelength maintaining agent, the absorption wavelength of light can be suppressed from being fixed by shifting the equilibrium state of the sensitizing dye to either oxidation or reduction until light is irradiated, and the storability of the composition can be improved.

In the adhesive or the sealant using the composition according to the present technology, a polymerization initiator may be mixed with the composition at the time of use. By mixing two materials of the composition according to the present technology and the polymerization initiator at the time of use, the storability of the composition can be further improved.

The object to be sealed in a case where the composition according to the present technology is used as a sealant is not particularly limited, and examples thereof include light emitting diode (LED) and the like.

### <8 Analysis Method>

### [Method for Analyzing Absorbance Retention Agent and Substance Derived Therefrom, and the Like, and Polymerizable Monomer and Substance Derived Therefrom]

Examples of a method for analyzing the absorption wavelength maintaining agent included in the optical member 20 or the hologram optical element and a substance derived therefrom include, but are not limited to, the following analysis method 1.

### <Analysis Method 1>

Analysis method: GC-MS (gas chromatography mass spectrometry)

Target substances for analysis: absorption wavelength maintaining agents, and decomposition products or reactants derived therefrom.

Measurement sample: a sample obtained by collecting the resin layer 12 from the optical member 20 or the exposed resin layer 12 from the hologram optical element. Note that details of the method of collecting these layers will be described later.

Details of measurement conditions of gas chromatography (GC) and mass spectrometry (MS) are as follows.

The analysis conditions are as follows.
Apparatus: GC (7890 A manufactured by Agilent technologies)/MS (5975 Cinert manufactured by Agilent technologies)
Column: DB-5 MS 0.25 mmID×30 m (film thickness 0.25 μm)
Oven temperature: 40° C. (5 min)−20° C./min−320° ° C. (10 min)
Inlet temperature: 280° C.
Carrier gas: He (constant flow rate mode, 1.0 ml/min)
Injection method: splitless
Interface temperature: 280° C.
Ionization chamber temperature: 250° C.
EM voltage: 2500 eV
Measured mass range: m/z 29-800
Injection amount: 1 μL

### Examples

Hereinbelow, the present technology will be described more specifically using examples. Note that the present technology is not limited to the contents of the following examples at all.

### <Raw Material of Laminated Film>

### (Sensitizing Dye)

MB: methylene blue (manufactured by Tokyo Chemical Industry Co., Ltd.)

BCp-1: (2E, 5E)-2,5-Bis [4-(diethylamino)phenyl)methylene]cyclopentanone (manufactured by ACROS ORGANICS)

### (Polymerizable Monomer)

EX212L: 6-hexanediol diglycidyl ether (manufactured by Nagase ChemteX Corporation)

OXT221: di [1-ethyl(3-oxetanyl)]methyl ether (manufactured by Toagosei Co., Ltd.)

EX121: 2-ethyl hexyl glycidyl ether (manufactured by Nagase ChemteX Corporation)

### (Absorption Wavelength Maintaining Agent/Reduction Inhibitor)

NBS: sodium m-nitrobenzenesulfonate (manufactured by Meisei Chemical Works, Ltd./product name: Ready Stick Salt)

### (Polymerization Initiator)

CPI-210S: triarylsulfonium salt type photo acid generator (manufactured by San-Apro Ltd.)

P3B: tetrabutylammonium=butyltriphenylborate (manufactured by Showa Denko K.K.)

### (Radical Polymerizable Organic Monomer)

Compound 6-3

Compound 11-13

### (Binder Resin)

UW-04FS: polyvinyl acetate (manufactured by Wacker)

### (Chain Transfer Agent)

2-MBT: 2-mercaptobenzothiazole (manufactured by Tokyo Chemical Industry Co., Ltd.)

### (Polymerization Inhibitor)

PT: Phenothiazine (manufactured by FUJIFILM Wako Pure Chemical Corporation)

### (UV Sensitizing Dye)

UVS1331: 9, 10 dibutoxyanthracene (manufactured by Kawasaki Kasei Chemicals Ltd.)

### (Polyalcohol)

PG: propylene glycol (1, 2-propanediol) manufactured by Tokyo Chemical Industry Co., Ltd.

### (Solvent)

Methyl ethyl ketone (manufactured by KANTO CHEMICAL CO., INC.)

Ethanol (manufactured by KANTO CHEMICAL CO., INC.)

### <Preparation of Hologram Recording Medium (Member)>

The raw materials described above were weighed at the ratio described in Table 1, and mixed in a solvent at normal temperature to prepare a composition.

As the solvent described above, a mixture obtained by mixing methyl ethyl ketone (manufactured by KANTO CHEMICAL CO., INC.) and ethanol (manufactured by KANTO CHEMICAL CO., INC.) in advance at a weight ratio of 80 and 20, respectively, was used.

The adjusted composition described above was applied onto a cycloolefin-based resin substrate layer having a thickness of 50 μm with a bar coater so that the dry film thickness was 5 μm.

Next, a surface opposite to a surface in contact with the substrate layer of the resin layer including the composition was pressure-bonded onto a glass substrate having a thickness of 1.0 mm to prepare a hologram recording medium (member).

### <Evaluation of Storage of Hologram Recording Medium (Member)>

The hologram recording medium (member) prepared described above was put in a double black bag and stored in a light-shielding manner for a period shown in Table 1. Absorbance spectra before and after storage were measured and evaluated by the following method. Since there is a possibility of photosensitivity if the hologram recording medium was taken out from the black bag, evaluation was performed using, as the sample after storage, another sample prepared under the same conditions on the same day instead of a sample used for measurement immediately after preparation.

### (Measurement of Absorbance)

A transmittance spectrum was calculated by measuring transmittance in a range of 400 nm or more and 700 nm or less using a spot light source manufactured by Hamamatsu Photonics K.K. as a light source and a small fiber optical spectrometer (USB-4000) manufactured by Ocean Optics, Inc. as a spectrometer. Using the calculated transmittance spectrum, the absorbance at a wavelength of 660 nm was determined. The results thereof are shown in Table 1.

### (Calculation of Absorbance Retention Rate)

The absorbance retention rate of the sample immediately after production of the hologram recording medium (member) and the sample after storage in a light-shielding manner for an any time was calculated and evaluated according to the following formula.

$$Retention rate = \frac{Diffraction efficiency after storage}{\begin{matrix}Diffraction efficiency \\ immediately after preparation\end{matrix}} \times 100 \qquad [ Mathematical Formula 1 ]$$

(Calculation of Absorbance Retention Rate after One Month Storage)

In order to equalize and compare the storage periods, it is assumed that the absorbance retention rate decreases linearly depending on the storage period, and the linear function of the graph shown in FIG. 17 is defined as the following formula. Thereafter, the absorbance retention rates of the sample immediately after preparation of the hologram recording medium (member) prepared described above and the sample after storage for one month were calculated and evaluated according to the following formula. The results thereof are shown in Table 1.

$$Retention rate ( 1 month ) = 744 \frac{A - 1}{T} + 1 \qquad [ Mathematical Formula 2 ]$$

A: Absorbance retention rate during any storage period
T: Any storage period

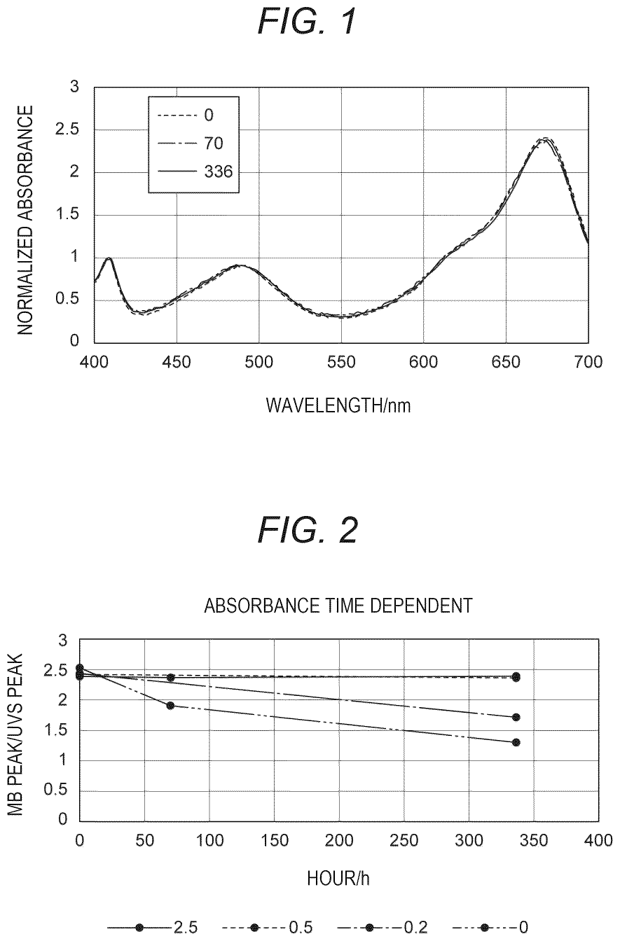

FIG. 1 is data showing a temporal change in a transmittance spectrum of a composition according to Example 1. For a hologram recording medium (member) including a resin layer including the above-described composition, a transmittance spectrum was measured by the above-described method for a sample immediately after production, a sample after a lapse of 70 hours, and a sample after a lapse of 336 hours.

As a result, it can be confirmed that in the composition according to Example 1, since the change in the waveform of the transmittance spectrum over time is small by containing the absorption wavelength maintaining agent, it is possible to suppress the fixation of the absorption wavelength of light due to a bias toward either oxidation or reduction in the equilibrium state of the sensitizing dye, and the storability of the composition is improved.

FIG. 2 is data showing the influence of the addition amount of an absorption wavelength maintaining agent on the storage stability of the composition according to the present technology. A composition was prepared in which sodium m-nitrobenzenesulfonate, which was a reduction inhibitor, was used as an absorption wavelength maintaining agent, the content thereof was set to 0% by mass, 0.2% by mass, 0.5% by mass, and 2.5% by mass, and the other components were adjusted to the composition of Example 1.

Using the compositions adjusted described above, a hologram recording medium (member) including a resin layer including each composition was prepared by the above-described method, and the change in the ratio of the absorbance of the sensitizing dye (methylene blue) at a wavelength of 660 nm to the absorbance of the UV sensitizing dye (9,10 dibutoxyanthracene) at a wavelength of 365 nm with the lapse of time is shown in the graph of FIG. 2.

As a result, it can be confirmed that a temporal change in absorbance can be suppressed by containing sodium m-nitrobenzenesulfonate as a reduction inhibitor. In particular, it can be confirmed that by containing 0.5% by mass or more of sodium m-nitrobenzenesulfonate, a temporal change in absorbance can be effectively suppressed, and the storability of the composition is improved.

### <Formation of Hologram>

With respect to the hologram recording medium (member) on the day of film production according to each of the presented Examples and Comparative Examples, before storage evaluation, it was confirmed that hologram formation was possible by the following method and that the resin layer including the above composition was visually transparent.

Furthermore, with respect to each of the presented hologram recording media (members) according to Examples and Comparative Examples after being stored for one month under the above-described conditions, it was confirmed that hologram formation was possible except for the presented Comparative Example.

All the hologram recording media (members) according to Examples and Comparative Examples were simultaneously subjected to two light fluxes exposure using three kinds of semiconductor lasers having wavelengths in a visible light region of 460 nm, 532 nm, and 660 nm, respectively, and the contained radical polymerizable organic monomer was diffused and cured in the composition. Thereafter, the entire surface was irradiated with UV (ultraviolet ray) to cure the uncured radical polymerizable organic monomer and polymerizable monomer, and the refractive index distribution was fixed to the hologram recording medium (member).

The hologram recording medium (member) was irradiated with UV light, and then heat-treated at 40° C. or more and 280° C. or less for 1 minute or more to further diffuse and cure the remaining radical polymerizable organic monomer and polymerizable monomer in the composition.

Note that as for the conditions of the two light fluxes exposure, the light intensity obtained by combining all kinds of laser beams was set to 35 W/cm², and the exposure was performed for 30 seconds. In addition, the angle formed by the two light fluxes was adjusted to be 16 degrees.

<Releasability from Glass Substrate>

For each hologram recording medium (member) according to Examples, the releasing surface of the resin layer when the resin layer was released at the interface between the glass substrate and the resin layer including the composition according to the present technology was evaluated according to the following criteria. The results are shown in Table 1.

### [Evaluation Criteria]

A. One in which no irregularities are observed on the surface of the resin layer, and which can be used as a hologram.
B. One that can be partially released from the glass substrate, but partially remains on it.
C. One in which the entire hologram film remains on the glass substrate.

TABLE 1

| | | Comparative | | Example 2 | Example 3 | Example 4 |
|---|---|---|---|---|---|---|
| | | Example 1 | Example 1 | NBS | NBS | NBS |
| | | NBS Absent | NBS | EX212L + | EX212L + | OXT221 + |
| [Compound kind] | [Details] | EX212L | EX212L | EX121 | EX121 | EX121 |
| polymerizable | EX212L | 21.35 | 21.25 | 10.62 | 2.81 | — |
| monomer | EX121 | — | — | 10.62 | 18.29 | 18.29 |
| (plasticizer) | OXT221 | — | — | — | — | 2.81 |
| Radical | Compound 6-3 | 28.05 | 27.91 | 27.91 | 27.97 | 27.97 |
| polymerizable | Compound 11-13 | 15.34 | 15.26 | 15.26 | 15.29 | 15.29 |
| organic monomer | | | | | | |
| Binder resin | UW-04FS | 18.81 | 18.72 | 18.72 | 18.76 | 18.76 |
| (matrix) | | | | | | |
| Sensitizing dye | MB•3H2O | 0.53 | 0.53 | 0.53 | 0.53 | 0.53 |
| | BCp-1 | 0.17 | 0.17 | 0.17 | 0.17 | 0.17 |
| Polymerization | CPI-210S | 6.57 | 6.54 | 6.54 | 6.55 | 6.55 |
| initiator | P3B | 3.32 | 3.30 | 3.30 | 3.31 | 3.31 |
| Chain transfer | 2-MBT | 0.54 | 0.54 | 0.54 | 0.54 | 0.54 |
| agent | | | | | | |
| Polymerization | PT | 0.08 | 0.08 | 0.08 | 0.08 | 0.08 |
| inhibitor | | | | | | |
| UV sensitizing | UVS-1331 | 1.35 | 1.34 | 1.34 | 1.35 | 1.35 |
| agent | | | | | | |
| Polyalcohol | PG | 3.88 | 3.86 | 3.86 | 3.87 | 3.87 |
| Absorption | NBS | — | 0.48 | 0.48 | 0.48 | 0.48 |
| wavelength | | | | | | |
| maintaining agent | | | | | | |

| | | | | | |
|---|---|---|---|---|---|
| Absorbance on same day | 2.52 | 2.04 | 2.09 | 2.03 | 1.94 |
| Absorbance after storage | 0.79 | 2.08 | 2.09 | 2.03 | 1.95 |
| Storage time (hour) | 720.00 | 1464.00 | 1464.00 | 1344.00 | 1344.00 |
| Absorbance retention rate during | 31.40 | 101.97 | 99.89 | 99.89 | 100.39 |
| storage | | | | | |
| Absorbance retention rate after 1 | 29.11 | 101.00 | 99.94 | 99.94 | 100.22 |
| month (linear approximation) | | | | | |
| Hologram formation capability | Not possible | Possible | Possible | Possible | Possible |
| after 1 month | | | | | |
| Releasability from glass substrate | C | C | B | A | A |

Unit of compound content: % by mass

### <Evaluation of Photocurability>

Furthermore, each of the compositions according to the presented Examples and Comparative Examples can also be used as a curing agent such as a sealant.

Each of the compositions according to Examples and Comparative Examples was evaluated by the following method before storage evaluation (on the day of preparation of the composition) and after storage in a dark place for one month. As a result, it was confirmed that each composition was curable and the resin layer including the composition was visually transparent before storage evaluation. On the other hand, after storage in a dark place for one month, only the composition according to Example could cure the composition and visually confirm the transparency.

Each of the compositions described above was applied in a sample tube including glass. At this time, for each composition, it was confirmed whether the applied portion of the composition could be visually confirmed.

In a state where each sample tube coated with the composition was sealed under a nitrogen atmosphere, the sample tube was irradiated with light having a wavelength of 660 nm, and then it was confirmed whether the composition flowed according to the inclination when the sample tube described above was inclined. In the case of flowing, it was determined that there was photocurability.

Note that it was confirmed that the composition according to Examples was cured to the deep part by irradiation with light having a long wavelength such as 660 nm described above. Therefore, the composition according to the present technology can be used so as to be cured to a deep portion that cannot be reached by short-wavelength light such as UV by photosensitization.

Note that the present technology can have the following configurations.

(1)

A composition including: a sensitizing dye that reversibly changes an absorption wavelength of light; a polymerizable monomer; and an absorption wavelength maintaining agent.

(2)

The composition according to (1), further including a polymerization initiator.

(3)

The composition according to (1) or (2), in which the absorption wavelength maintaining agent includes an oxidation-reduction inhibitor.

(4)

The composition according to any one of (1) to (3), including 1 mol or more of the absorption wavelength maintaining agent per 1 mol of the sensitizing dye.

(5)

The composition according to any one of (1) to (4), in which the polymerizable monomer includes a cationic polymerizable monomer, and the absorption wavelength maintaining agent includes a reduction inhibitor.

(6)

The composition according to (5), in which the reduction inhibitor includes at least one selected from a nitro compound, a peroxide, and a halogen-based compound.

(7)

The composition according to (5) or (6), in which the reduction inhibitor includes at least one selected from nitrobenzene sulfonate, methanitrobenzene sulfonate, nitronaphthalene sulfonate, vanadate, nitrite, chlorate, perchlorate, and percarbonate.

(8)

The composition according to any one of (5) to (7), in which the cationic polymerizable monomer includes one or more cyclic ether-based compounds.

(9)

The composition according to any one of (1) to (8), in which the sensitizing dye includes at least one compound selected from a thiazine-based compound, an azine-based compound, and a cyanine-based compound.

(10)

The composition according to any one of (2) to (9), in which the polymerization initiator includes one or more onium compounds.

(11)

The composition according to (10), in which one or more of the onium compounds includes a salt of a triarylborate-based compound.

(12)

The composition according to any one of (1) to (11), further including a binder resin and a radical polymerizable organic monomer.

(13)

A laminated film including one or more layers including the composition according to any one of (1) to (12).

(14)

The laminated film including a substrate layer, a resin layer, and a release layer in this order, in which the resin layer includes the composition according to any one of (1) to (12).

(15)

A member including a resin layer on at least a part of a surface, the resin layer being formed by exposing the composition according to any one of (1) to (12).

(16)

A member including a resin layer on at least a part of a surface, in which the resin layer includes a sensitizing dye or a derivative of the sensitizing dye that reversibly changes an absorption wavelength of light, a polymer of a polymerizable monomer, and an absorption wavelength maintaining agent.

(17)

A method for adhering an object, in which the composition according to any one of (1) to (12) is used as an adhesive.

(18)

A method for adhering an object, in which a mixture of the composition according to any one of (1) to (12) and a polymerization initiator is used as an adhesive.

(19)

A sealing method using the composition according to any one of (1) to (12) as a sealant.

### REFERENCE SIGNS LIST

10 Laminated film
11 Substrate layer
12 Photosensitive layer
13 Release layer
14 Adhesive layer
20 Member (optical member)
21 Member main body
22 Adhesion assisting tool (roller)
31A, 31B, 31C Diode-pumped solid-state laser
32A, 32B, 32C Electronic shutter
33A, 33B, 33C Half-wave plate
34A, 34B, 34C Objective lens
35A, 35B, 35C Beam expander
36 Mirror
37 Dichroic mirror
38 Dichroic mirror
39 Light halo aperture
40 Beam splitter
41 Mirror
42 Mirror
44 First light flux
45 Second light flux

1. A composition comprising: a sensitizing dye that reversibly changes an absorption wavelength of light; a polymerizable monomer; and an absorption wavelength maintaining agent.

2. The composition of claim 1, further comprising a polymerization initiator.

3. The composition according to claim 1, wherein the absorption wavelength maintaining agent comprises an oxidation-reduction inhibitor.

4. The composition according to claim 1, comprising 1 mol or more of the absorption wavelength maintaining agent per 1 mol of the sensitizing dye.

5. The composition according to claim 1, wherein the polymerizable monomer comprises a cationic polymerizable monomer, and the absorption wavelength maintaining agent comprises a reduction inhibitor.

6. The composition according to claim 5, wherein the reduction inhibitor comprises at least one selected from a nitro compound, a peroxide, and a halogen-based compound.

7. The composition according to claim 5, wherein the reduction inhibitor comprises at least one selected from nitrobenzene sulfonate, methanitrobenzene sulfonate, nitronaphthalene sulfonate, vanadate, nitrite, chlorate, perchlorate, and percarbonate.

8. The composition according to claim 5, wherein the cationic polymerizable monomer comprises one or more cyclic ether-based compounds.

9. The composition according to claim 1, wherein the sensitizing dye comprises at least one compound selected from a thiazine-based compound, an azine-based compound, and a cyanine-based compound.

10. The composition according to claim 2, wherein the polymerization initiator comprises one or more onium compounds.

11. The composition according to claim 10, wherein one or more of the onium compounds comprises a salt of a triarylborate-based compound.

12. The composition according to claim 1, further comprising a binder resin and a radical polymerizable organic monomer.

13. A laminated film comprising one or more layers including the composition according to claim 1.

14. A laminated film comprising a substrate layer, a resin layer, and a release layer in this order,
wherein the resin layer includes the composition according to claim 1.

15. A member comprising a resin layer on at least a part of a surface, wherein the resin layer is formed by exposing the composition according to claim 1.

16. A member comprising a resin layer on at least a part of a surface, wherein the resin layer includes a sensitizing dye or a derivative of the sensitizing dye that reversibly changes an absorption wavelength of light, a polymer of a polymerizable monomer, and an absorption wavelength maintaining agent.

17. A method for adhering an object, wherein the composition of claim 1 is used as an adhesive.

18. A method for adhering an object, wherein a mixture of the composition of claim 1 and a polymerization initiator is used as an adhesive.

19. A sealing method using the composition of claim 1 as a sealant.
